(19) United States
(12) Patent Application Publication
(10) Pub. No.: US 2025/0021392 A1
(43) Pub. Date: Jan. 16, 2025

(54) LONG DURATION TASK MONITORING INSTRUMENTATION

(71) Applicant: Dell Products L.P., Round Rock, TX (US)

(72) Inventors: Saif Ahmed, Reston, VA (US); Nikhil Shingte, Alpharetta, GA (US); Ching-Yun Chao, Austin, TX (US)

(21) Appl. No.: 18/351,215

(22) Filed: Jul. 12, 2023

(51) Int. Cl. G06F 9/50

(52) U.S. Cl. CPC G06F 9/5044

(57) ABSTRACT

Automated long duration monitoring of tasks and transactions can be enhancedly performed and managed. A monitor component can track respective processing states of respective service requests associated with respective services in connection with a task or transaction based on respective service request messages communicated to respective devices associated with the respective services, respective response messages received from the respective devices, or respective update messages that update respective processing statuses of the respective service requests, wherein the respective service request messages, respective response messages, or respective update messages can comprise a correlation identifier that identifies the task or transaction. A monitor manager component can determine the respective processing states of the respective service requests associated with the respective services, based on the tracking, and can determine a status of the task or transaction based on the respective processing states of the respective service requests.

### BACKGROUND

Devices (e.g., communication devices, user equipment (UE), nodes, or other type of device) can communicate in a communication network environment. The devices can perform various types of operations in connection with providing various services (e.g., authentication of devices or entities, order processing and fulfillment, manufacturing, shipping, provisioning, performing analysis on data, performing computations on data, and/or other operations or services). In connection with a task or transaction, a service may invoke one or more other services to perform respective sub-tasks to facilitate performance of the task or transaction. Depending on the task or transaction, a service(s) of the one or more other services may invoke still one or more other services to perform respective sub-tasks to assist such service(s) in performing its sub-task. Depending on the task or transaction, in some instances, it may take a relatively long time (e.g., hours, days, or weeks) for the respective services to process and respond to the respective service requests and perform the respective sub-tasks.

The above-described description is merely intended to provide a contextual overview regarding communication networks, devices, and services, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise, tracking, by a system comprising a processor, respective processing states of respective service requests associated with respective services in connection with performance of a task based on respective service request messages communicated to respective devices associated with the respective services, respective response messages received from the respective devices associated with the respective services, or respective update messages updating respective processing statuses of the respective service requests, wherein the respective service request messages, the respective response messages, or the respective update messages can comprise a correlation identifier that can identify the task. The method also can include, based on the tracking, determining, by the system, the respective processing states of the respective service requests associated with the respective services. The method further can comprise determining, by the system, a status of the performance of the task based on the respective processing states of the respective service requests associated with the respective services.

In certain embodiments, the disclosed subject matter can comprise a system that can include a memory that can store computer executable components, and a processor that can execute computer executable components stored in the memory. The computer executable components can comprise a monitor component that can monitor and track respective processing states of respective service requests associated with respective services in connection with a transaction based on respective items of service request data communicated to respective nodes associated with the respective services, respective items of response data received from the respective nodes associated with the respective services, or respective items of update data that update respective processing statuses of the respective service requests, wherein the respective items of service request data, the respective items of response data, or the respective items of update data can comprise a transaction identifier that can identify the transaction. The computer executable components also can comprise a monitor manager component that can determine the respective processing states of the respective service requests associated with the respective services, based on the monitoring and the tracking, and can determine a status of the transaction based on the respective processing states of the respective service requests associated with the respective services.

In still other embodiments, the disclosed subject matter can comprise a non-transitory machine-readable medium, comprising executable instructions that, when executed by a processor, can facilitate performance of operations. The operations can comprise monitoring respective processing states of respective service requests associated with respective services in connection with performance of a task based on respective service request messages communicated to respective devices associated with the respective services, respective response messages received from the respective devices associated with the respective services, or respective update messages updating respective processing statuses of the respective service requests, wherein the respective service request messages, the respective response messages, or the respective update messages can comprise a correlation identifier that can identify the task. The operations also can comprise, based on the monitoring, determining the respective processing states of the respective service requests associated with the respective services. The operations further can comprise determining a status of the performance of the task based on the respective processing states of the respective service requests associated with the respective services.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably perform and manage automated monitoring of tasks, transactions, and operations, including automated long duration monitoring of tasks, transactions, and operations, in accordance with various aspects and embodiments of the disclosed subject matter.

FIG. 2 depicts a block diagram of a non-limiting example monitor manager component, in accordance with various aspects and embodiments of the disclosed subject matter.

FIG. 3 illustrates a block diagram of a non-limiting example operational process for monitoring of service requests associated with a task across multiple services, in accordance with various aspects and embodiments of the disclosed subject matter.

FIG. 4 illustrates a block diagram of a non-limiting example system that can desirably perform and manage automated monitoring of tasks, transactions, and operations, including automated long duration monitoring of tasks, transactions, and operations, utilizing interceptor components to facilitate such monitoring, in accordance with various aspects and embodiments of the disclosed subject matter.

FIG. 5 depicts a block diagram of a non-limiting example monitoring instrumentation automation using sidecar injection where a sidecar can be utilized to host an interceptor component, in accordance with the various aspects and embodiments of the disclosed subject matter.

FIG. 6 depicts a block diagram of a non-limiting example operational process for monitoring of service requests associated with a task across multiple services where an intercept component can be employed in connection with a service, in accordance with the various aspects and embodiments of the disclosed subject matter.

FIG. 7 illustrates a flow chart of an example method that can desirably perform automated monitoring of tasks, in accordance with various aspects and embodiments of the disclosed subject matter.

FIG. 8 presents a flow chart of another example method that can desirably perform automated monitoring of tasks, in accordance with various aspects and embodiments of the disclosed subject matter.

FIG. 9 illustrates an example block diagram of an example computing environment in which the various embodiments of the embodiments described herein can be implemented.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to automated long duration monitoring (LDM) of tasks, transactions, and/or operations, and can comprise a general framework to monitor eventual successful completion of tasks, transactions, and/or operations that can span many dependent services over a relatively long period of time. Examples of automated LDM usage scenarios can include product and service (e.g., consumer or cloud service) offerings order and fulfillment processing and product and service subscription provision and lifecycle orchestration management that sometimes can take hours, days, or even weeks to complete.

Operations that can span across multiple dependent services can be more difficult to monitor than other types of operations, such as operations that do not span across multiple dependent services or other less complex operations. For example, identity federated single sign-on (SSO) scenarios that can span multiple identity management services across multiple enterprise security domains can be difficult to monitor end-to-end. While the SSO operation typically can be completed in a second or less, a web client (e.g., browser) federated identity authentication process can involve multiple service redirections which typically cannot be tracked by existing monitoring systems. These existing monitoring tools can be based on tracing and consolidating various transactions across various services, over short duration. If a long duration transaction executes across multiple clusters, such as multiple clusters that run containerized applications, instrumentation using existing monitoring tools may not suffice. Ordering processing from placing orders, credit and compliance validation, payment and billing processing, fulfillment, manufacturing and shipping, and/or onboarding and provisioning often can take days to weeks to complete.

Also, some existing monitoring tools undesirably can depend on running daemonsets to monitor an application associated with a task or transaction. These existing monitoring tools undesirably may introduce code dependencies in the application container to instrument monitoring. Further, other existing monitoring tools can rely upon instrumentation using java agents or provide libraries to instrument, which undesirably may require application code changes. Some of these existing monitoring tools can handle synchronous request monitoring, but undesirably can only handle very limited asynchronous request monitoring, and thus, can be deficient and ineffective in performing long duration process monitoring of tasks and transactions. Some other of these existing monitoring tools may be able to be utilized for limited asynchronous process troubleshooting with regard to monitoring of tasks and transactions, but undesirably do not have real time monitoring capability to monitor tasks and transactions in real time or near real time.

It can be desirable to overcome the deficiencies of the existing techniques relating to monitoring of tasks, transactions, and operations, particularly with regard to long duration monitoring of tasks, transactions, and operations.

To that end, techniques for desirably (e.g., efficiently, suitably, enhancedly, or optimally) performing and managing automated monitoring of tasks, transactions, and operations, including automated long duration monitoring of tasks, transactions, and operations, are presented. In some embodiments, the system can comprise a monitor component that can monitor and track respective processing states (e.g., successfully completed, failure to complete, or timeout of service request) of respective service requests associated with respective services in connection with a task (e.g., task associated with a transaction and/or other task) based at least in part on the monitoring and tracking of respective service request messages communicated to respective devices associated with the respective services, respective response messages received from the respective devices associated with the respective services, or respective update messages that update respective processing statuses of the respective service requests. To facilitate the monitoring and tracking of messages and the respective processing states of the respective service requests, the respective service request messages, the respective response messages, and/or the respective update messages can comprise a correlation identifier that can identify the task (e.g., correlation identifier that can identify the task or transaction with regard to which the message is related) and/or a service request that invoked or requested a service.

The system also can comprise a monitor manager component that can perform a monitoring service or processes (e.g., automated monitoring service or processes) to perform (e.g., automatically perform) monitoring, such as long duration monitoring, of tasks, transactions, and/or operations. In some embodiments, the monitoring service can be a centralized monitoring service. The monitor manager component can determine the respective processing states of the respective service requests associated with the respective services, based at least in part on results of the tracking of the respective processing states of respective service requests associated with respective services. The monitor manager component can determine a status of the task based at least in part on the respective processing states of the respective service requests associated with the respective services.

In certain embodiments, to facilitate the long duration monitoring, in connection with a service request for a second service by a first service, the monitor manager component can generate a monitoring service record that can comprise various types of information relating to the service request, including the correlation identifier associated with the task or transaction and/or associated with the service request being made by the first service, and/or associated with a previous service request for the first service by another service, if the other service issued the previous service request for the first service in connection with the task or transaction, a timeout period for performance of the second service (e.g., performance of the sub-task by the second service), a second service identifier associated with (e.g., identifying) the second service, a first service identifier associated with the first service, a time of the service request, and/or other desired information relating to the task or requested service. The monitor manager component can update the monitoring service record based at least in part on any update information (e.g., response or update message that can update the status of the service request, such as an update indicating successful performance of the requested service, or failure to complete the requested service) received from a first device associated with the first service or a second device associated with the requested or invoked service (e.g., second service), other update information indicating that a timeout period associated with the service request has expired, and/or other type of update information relating to the service request.

In some embodiments, the system can employ interceptor components that can intercept, manage, and/or filter inbound messages and outbound messages associated with the services. The inbound messages and outbound messages can comprise or relate to service request messages, response messages (e.g., response to request messages), update messages, status messages, or other types of messages. In some embodiments, an interceptor component associated with a service can be chained or inserted into an inbound and outbound message processing path associated with the service. The interceptor component can intercept and process an incoming message before forwarding the incoming message to the service, and can intercept and process an outgoing message from the service before forwarding the outgoing message to another service or entity, such as described herein.

The monitor manager component, employing the monitor component, can receive information relating to the service request messages (e.g., service request messages, response messages, service request status update messages, and/or other information) from each of the interceptor components associated with the task. Such information can comprise the correlation identifier associated with the task to facilitate the monitoring of the task by the monitor manager component.

The techniques employed by the monitor manager component, interceptor components, and/or other components of the system desirably can be programming language agnostic and not code dependent (e.g., can be code independent or otherwise not code dependent) with regard application containers, and can eliminate having to utilize manual instrumentation in the monitoring process to monitor (e.g., automatically perform automated long duration monitoring of) tasks, transactions, and operations. For instance, instrumentation via the interceptor components can automate instrumentations without touching or interacting with service (e.g., microservice) source code, and the instruments in the interceptor components can be independent from choice of microservice programming languages.

In some embodiments, the system can comprise a mitigation component that can receive mitigation requests from the monitor manager component if and when there is a failure, or multiple failures, of a service to timely perform a service request relating to the task or a timeout, or multiple timeouts, associated with a service request or service requests associated with a service where a specified time for performing the requested service has elapsed without an indication (e.g., response message) from the service regarding whether the requested service has been successfully performed or has failed to be performed. The mitigation component can analyze information relating to failure(s) of performance of services, including historical information relating to service performance failures. Based at least in part on the results of such analysis, the mitigation component can determine which service(s) is the culprit of a service performance failure, can determine whether there is a pattern (e.g., repeated pattern) associated with such service failures, and/or can determine a mitigation action that can be performed to mitigate (e.g., reduce, minimize, or eliminate) future failures to perform services in response to service requests. Similarly, the mitigation component can analyze information relating to timeouts associated with service requests, including historical information relating to timeouts associated with service requests. Based at least in part on the results of such analysis, the mitigation component can determine which service(s) is causing the timeout condition associated with a service request(s), can determine whether there is a pattern associated with such timeout conditions, and/or can determine a mitigation action (e.g., adjust a timeout value, or other mitigation action) that can be performed to mitigate (e.g., reduce, minimize, or eliminate) future timeouts associated with performing such services in response to service requests.

These and other aspects and embodiments of the disclosed subject matter will now be described with respect to the drawings.

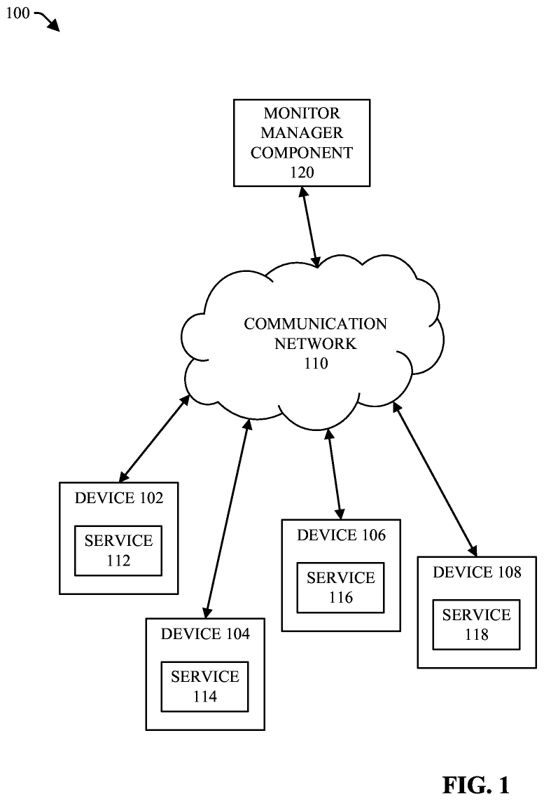

Referring now to the drawings, FIG. 1 illustrates a block diagram of a non-limiting example system 100 that can desirably (e.g., efficiently, suitably, enhancedly, or optimally) perform and manage automated monitoring of tasks, transactions, and operations, including automated long duration monitoring of tasks, transactions, and operations, in accordance with various aspects and embodiments of the disclosed subject matter. The system 100 can comprise a group of devices (e.g., communication devices, nodes, or node equipment or devices), which can comprise a desired number of devices, including device 102, device 104, device 106, device 108, and/or one or more other devices. At desired times, the devices (e.g., 102, 104, 106, and/or 108) can be associated with (e.g., communicatively connected) a communication network 110 to facilitate communication of data between a device (e.g., 102, 104, 106, or 108) and the communication network 110, and/or facilitate communication of data between the devices via the communication network 110.

The respective devices (e.g., 102, 104, 106, and/or 108) can comprise, employ, and/or access data processing resources (e.g., processor(s)), storage resources (e.g., data store(s)), applications, and/or other resources that can enable the respective devices to each perform one or more respective services (e.g., microservices or other types of services), such as service 112, service 114, service 116, and service 118. The one or more services can be or can relate to, for example, data communications, data processing, orders or subscriptions for products and/or services, provisioning of services, video streaming, audio streaming, data security or protection, multimedia service, news service, financial service, social networking, and/or another desired type of service. With regard to orders for products or services, a service (e.g., 112, 114, 116, and/or 118) can perform various types of services in connection with an order for a product or service, wherein such types of services and tasks (e.g., sub-tasks of an overall task) can comprise, for example, order processing (e.g., various types of order processing from placement of an order to fulfillment of the order), authentication of one or more entities associated with the order or transaction, credit and compliance validation, billing and payment processing, order fulfillment, manufacturing of the product, shipping of the product, onboarding associated with a service or product, provisioning associated with a service or product, and/or other types of services.

A device (e.g., 102, 104, 106, or 108) can be a computer, a laptop computer, a server, a wireless, mobile, or smart phone, electronic pad or tablet, a virtual assistant (VA) device, electronic eyewear, electronic watch, or other electronic bodywear, an electronic gaming device, an Internet of Things (IoT) device (e.g., health monitoring device, toaster, coffee maker, blinds, music players, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term user equipment (UE) can be used. The respective devices (e.g., 102, 104, 106, and/or 108) can be associated with (e.g., communicatively connected to) the communication network 110 and/or each other via respective communication connections and channels, which can include wireless or wireline communication connections and channels.

The communication network 110 can comprise various network equipment (e.g., routers, gateways, transceivers, switches, base stations, access points, radio access networks (RANs), or other devices) that facilitate (e.g., enable) communication of information between respective items of network equipment of the communication network 110, communication of information between the devices (e.g., 102, 104, 106, and/or 108) and the communication network 110, and communication of information between the devices. The communication network 110 can provide or facilitate wireless or wireline communication connections and channels between the respective devices (e.g., 102, 104, 106, and/or 108), and respectively associated services (e.g., 112, 114, 116, and/or 118), and the communication network 110. For reasons of brevity or clarity, the various network equipment, components, functions, or devices of the communication network 110 are not explicitly shown.

It is to be appreciated and understood that, while the system 100 depicts four devices (e.g., 102, 104, 106, and/or 108) and four services (e.g., 112, 114, 116, and/or 118) respectively associated therewith, in some embodiments, the system 100 (or other systems described herein) can employ more or less than four devices and/or more or less than four services. Also, a device (e.g., 102, 104, 106, or 108) can comprise, be associated with, or perform one or more services of one or more service types.

At various times, it can be desired to perform or execute certain tasks or transactions that can involve one or more of the services (e.g., 112, 114, 116, and/or 118). In some instances, with regard to a task or transaction (e.g., a transaction that can involve the performance of a task, which can comprise one or more sub-tasks), the task or transaction can be a long duration task or transaction that can take a relatively long period of time to perform or execute and/or that can involve multiple services performing respective sub-tasks or services in connection with the task or transaction, wherein some of the services can be dependent on other services. As an example of dependent services, in connection with performance of a task, a first service can request that a second service perform a sub-task in connection with performance of the task, and, to facilitate the second service performing its sub-task, and the overall performance of the task by the first service, the second service can request that one or more other services perform one or more other sub-tasks (e.g., on behalf of the second service) and/or provide the results of the performance of the one or more other sub-tasks to the second service, and wherein the second service can provide results of the performance of its sub-task to the first service. In this example of dependent services, the first service can be dependent on the second service and the one or more other services (e.g., the downstream services from the first service), and the second service can be dependent on the one or more other services that are downstream from and invoked by the second service.

It can be desirable to monitor and track the status and/or progress of tasks, transactions, and/or operations associated with the respective services (e.g., 112, 114, 116, and/or 118), including long duration tasks and/or transactions associated with the respective services, and including respective services, sub-tasks, and/or operations performed by respective services, wherein there can be dependency of some services on other services in connection with performance of the tasks and/or transactions.

To that end, in accordance with various embodiments, the system 100 can comprise a monitor manager component 120 that can desirably (e.g., suitably, efficiently, enhancedly, and/or optimally) monitor and/or track (e.g., perform automated long duration monitoring and/or tracking of) status and/or progress of the respective tasks, transactions, and/or operations associated with (e.g., requested or performed by) the respective services (e.g., 112, 114, 116, and/or 118).

For instance, with regard to a task or transaction, the monitor manager component 120 can monitor and track respective service requests made by services to other services, and respective statuses (e.g., processing states) of the respective service requests. In some embodiments, the monitor manager component 120 can employ a correlation identifier that can be associated with the task or transaction, wherein the correlation identifier can be associated with service request messages, response messages (e.g., responses to service requests), update messages, and/or monitoring service records associated with the task or transaction, to facilitate the monitoring and/or tracking (e.g., by the monitor manager component 120) of service requests, processing states of service requests, and/or other aspects associated with the task or transaction. The monitor manager component 120 can determine respective processing states of the respective service requests associated with the respective services, based at least in part on results of the monitoring and tracking of the respective service requests, including respective processing of respective service requests by the respective services requested or invoked to perform desired services in response to the respective service requests, such as described herein. The monitor manager component 120 can determine a status (e.g., an overall status) of the task or transaction based at least in part on the respective processing states of the respective service requests associated with the respective services. In certain embodiments, the monitor manager component 120 can simultaneously or concurrently perform (e.g., perform in parallel) long duration monitoring and/or tracking of multiple tasks or transactions, including multiple services requests associated with multiple tasks or transactions, in real time or near real time.

The monitor manager component 120 also can present (e.g., display or communicate) information relating to the task or transaction, the service requests, the services, and/or the respective processing states of the respective service requests to a user associated with the monitor manager component 120 and/or a device(s) (e.g., 102, 104, 106, and/or 108) associated with a service(s) (e.g., 112, 114, 116, and/or 118) and/or a user(s). In some embodiments, if and when issues, such as service request failures or timeout conditions associated with service requests occur, the monitor manager component 120 can employ a mitigation service to facilitate determining a mitigation action(s) that can be taken to mitigate (e.g., reduce, minimize, or reduce or minimize the effects of, or otherwise mitigate) service request failures or timeout conditions associated with service requests, such as described herein.

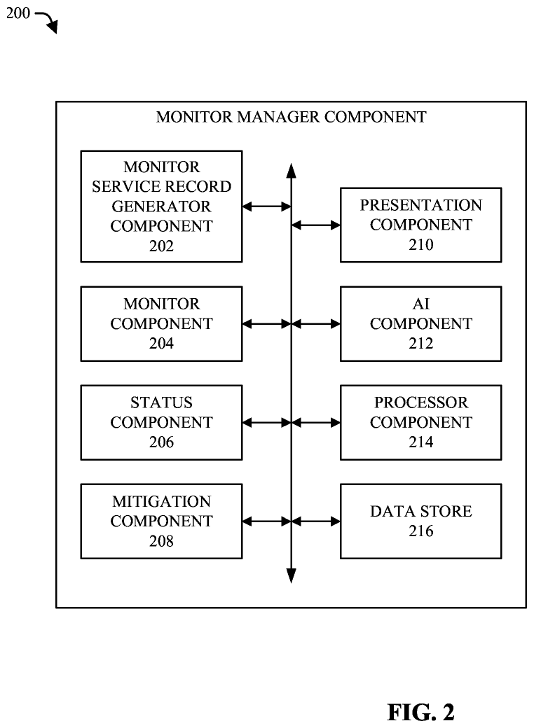

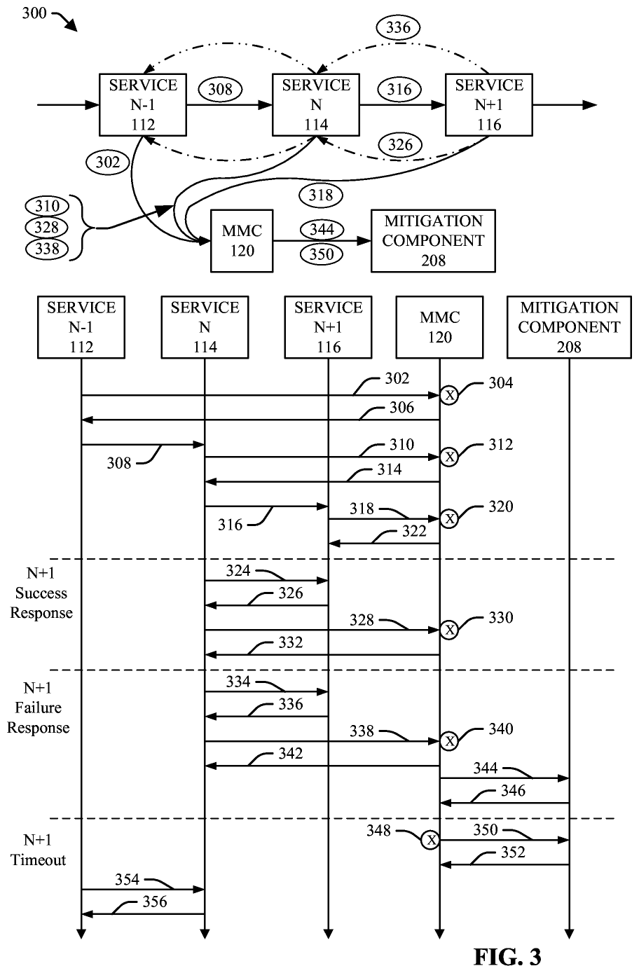

Referring to FIGS. 2 and 3 (along with FIG. 1), FIG. 2 depicts a block diagram of a non-limiting example monitor manager component 120, and FIG. 3 illustrates a block diagram of a non-limiting example operational process 300 (e.g., an operational sequence) for monitoring (e.g., long duration monitoring) of service requests associated with a task across multiple services, in accordance with the various aspects and embodiments of the disclosed subject matter. The example operational process 300 can involve multiple services, including service 112 (also referred to herein and in the drawings as service N−1 112), service 114 (also referred to herein and in the drawings as service N 114), and service 116 (also referred to herein and in the drawings as service N+1 116), wherein, in connection with a task to be performed, the service 112 can invoke the service 114 to perform a first service, and, in connection with the service 114 performing the first service, the service 114 can invoke the service 116 to perform a second service. As part of the example operational process 300, the monitor manager component (MMC) 120 can monitor service requests associated with the task, and associated messages and events, across these multiple services (e.g., 112, 114, 116).

The service 112 can desire to, or can be engaged to, perform the task (e.g., task associated with or involving a transaction, or other type of task). In connection with performance of the task, the service 112 can desire to invoke the service 114, via a first service request, to perform the first service to facilitate performance of the task. In connection with issuing a first service request to the service 114, the service 112, via the device 102, can communicate a request to have a monitoring service record created for the first service request, as indicated at reference numeral 302 of the operational process 300. As part of or in connection with the request, the service 112 can provide service request-related information, including a first service identifier that can identify the service 112 that is issuing the first service request, a second service identifier that can identify the service 114 that is to perform the first service, a timeout period indicating an amount of time that the service 114 can have to perform the first service, information that can inform or request the monitor manager component 120 to update the processing state associated with the first service request if and when a response message indicating a success in performing the first service or a failure to perform the first service is received from the service 114, and/or other service request-related information associated with the first service request.

As indicated at reference numeral 304, the monitor manager component 120, employing a monitoring service record generator component 202, can generate (e.g., create) a first monitoring service record relating to the first service request. The first monitoring service record can comprise a first monitoring service record identifier that can identify the first monitoring service record, a correlation identifier that can be associated with and can identify the task and the service 112, the first service identifier associated with the service 112, the second service identifier associated with the service 114, the timeout period, an update indicator that indicates the processing state is to be updated in the first monitoring service record if and when a response message is received from the service 114, and/or other service request-related information associated with the first service request. As indicated at reference numeral 306 of the operational process 300, the monitor manager component 120 can communicate an acknowledgement message to the service 112, via the associated device 102, wherein the acknowledgement message can indicate that the first monitoring service record was created, and/or can comprise the first monitoring service record identifier and/or the correlation identifier associated with the task.

As indicated at reference numeral 308 of the operational process 300, the service 112, via the device 102, can communicate the first service request to the service 114, via the device 104, to request that the service 114 perform the first service. In some embodiments, the first service to be performed by the service 114 can be an asynchronous service. The first service request can comprise the first monitoring service record identifier, the correlation identifier associated with the task and/or the service 112, the first service identifier associated with the service 112, and/or other desired information relating to the first service request. In some embodiments, with regard to service request messages, response messages in response to service requests, or update messages relating to service requests, the respective identifiers (e.g., monitoring service record identifier, correlation identifier, service identifier, or other identifier) and/or other information can be part of header information or metadata of or associated with the respective messages.

In response to receiving the first service request, the service 114 can recognize or determine that, in connection with the service 114 performing the first service, it can be desirable (e.g., wanted, needed, or otherwise desired) for the service 114 to invoke the service 116 to perform a second service (e.g., to facilitate the performing of the first service). Accordingly, in connection with the service 114 issuing a second service request to the service 116, the service 114, via the device 104, can communicate a request to have a monitoring service record (e.g., a second monitoring service record) created for the second service request, as indicated at reference numeral 310 of the operational process 300. As part of or in connection with the request to have the second monitoring service record, the service 114 can provide service request-related information, including the correlation identifier associated with the task and/or the service 112, the second service identifier that can identify the service 114 that is issuing the second service request, a third service identifier that can identify the service 116 that is to perform the second service, a timeout period indicating an amount of time that the service 116 can have to perform the second service, information that can inform or request the monitor manager component 120 to update the processing state associated with the second service request if and when a response message indicating a success in performing the second service or a failure to perform the second service is received from the service 116, and/or other service request-related information associated with the second service request.

As indicated at reference numeral 312, the monitoring service record generator component 202 can generate a second monitoring service record relating to the second service request. The second monitoring service record can comprise a second monitoring service record identifier that can identify the second monitoring service record, the correlation identifier associated with the task and/or the service 112, the second service identifier associated with the service 114, the third service identifier associated with the service 116, the timeout period associated with (e.g., applicable to) the second service request, an update indicator that can indicate that the processing state is to be updated in the second monitoring service record if and when a response message is received from the service 116, and/or other service request-related information associated with the second service request. As indicated at reference numeral 314 of the operational process 300, the monitor manager component 120 can communicate an acknowledgement message to the service 114, via the associated device 104, wherein the acknowledgement message can indicate that the second monitoring service record was created, and/or can comprise the second monitoring service record identifier, the correlation identifier associated with the task, and/or other desired information relating to the task.

As indicated at reference numeral 316 of the operational process 300, the service 114, via the device 104, can communicate the second service request to the service 116, via the device 106, to request that the service 116 perform the second service. In some embodiments, the second service to be performed by the service 116 can be an asynchronous service. The second service request can comprise the second monitoring service record identifier, the correlation identifier associated with the task and/or the service 112, the second service identifier associated with the service 114, and/or other desired information relating to the second service request.

In certain embodiments, in response to receiving the second service request, the service 116, via the device 106, can communicate a request to have a monitoring service record (e.g., a third monitoring service record) created, as indicated at reference numeral 318 of the operational process 300. As part of or in connection with the request to have the third monitoring service record created, the service 116 can provide service request-related information, including the correlation identifier associated with the task and/or the service 112, the third service identifier associated with the service 116, and/or other desired information relating to the task.

As indicated at reference numeral 320, the monitoring service record generator component 202 can generate a third monitoring service record associated with the service 116. The third monitoring service record can comprise a third monitoring service record identifier that can identify the third monitoring service record, the correlation identifier associated with the task and/or the service 112, the third service identifier associated with the service 116, and/or other desired information. As indicated at reference numeral 322 of the operational process 300, the monitor manager component 120 can communicate an acknowledgement message to the service 116, via the associated device 106, wherein the acknowledgement message can indicate that the third monitoring service record was created, and/or can comprise the third monitoring service record identifier, the correlation identifier associated with the task, and/or other desired information relating to the task.

The monitor manager component 120, employing a monitor component 204, can monitor and/or track the service requests, including the first service request and the second service request, associated with the task to facilitate determining whether the first service request and/or the second service request have been successfully performed or have failed to be performed, and/or whether the respective timeout periods associated with the first service request and/or second service request has or have expired without a response or update message being received. In some embodiments, to facilitate obtaining or determining a status of a service request, a requesting service (e.g., service 114) that issued the service request (e.g., second service request) can invoke a get status (e.g., obtain status) with regard to the service request by communicating a get status request message to the requested service (e.g., service 116), wherein the get status request message can comprise the correlation identifier associated with the task and/or the service 112, the monitoring service record identifier(s) associated with the monitoring service record(s) associated with the service request, task, and/or service, and/or other desired information relating to the service request. In other embodiments, an event notification approach can be employed by the services (e.g., 112, 114, 116) such that, when an event relating to a service request occurs, such as a successful performance of a requested service in response to a service request, or a failure to perform a requested service in response to a service request, the service invoked to perform the requested service can communicate an event notification or status message, which can indicate whether the requested service was successfully performed or failed to be performed by such service, to the requestor service that issued the service request, wherein such event notification or status message also can comprise the correlation identifier associated with the task and/or the service 112, the monitoring service record identifier(s) associated with the monitoring service record(s) associated with the service request, task, and/or service, and/or other desired information relating to the service request.

For instance, with regard to the example operational process 300, which can employ exemplary get status requests, there can be different scenarios in which the second service can be successfully performed by the service 116, the second service can fail to be performed by the service 116, or the applicable timeout period associated with the second service request can expire without a response or update message being received from the service 116. In that regard, in an example instance, with regard to a scenario in which the second service can be successfully and timely performed by the service 116, and in connection with the second service request, the service 114, via the device 104, can communicate a get status message (e.g., prior to expiration of the timeout period) to the service 116, via the device 106, to facilitate determining the status of the performance of the second service request, as indicated at reference numeral 324 of the operational process 300. The get status request message can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

In this example instance, in response to receiving the get status message, the service 116, via the device 106, can communicate a response message (e.g., prior to expiration of the timeout period) to the service 114, via the device 104, wherein the response message can indicate that the second service has been successfully performed by the service 116, as indicated at reference numeral 326 of the operational process 300. The response message can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

In response to the response message indicating successful performance of the second service, the service 114, via the device 104, can communicate an update message to the monitor manager component 120, wherein the update message can indicate the successful performance of the second service by the service 116, as indicated at reference numeral 328 of the operational process 300. The update message also can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

As indicated at reference numeral 330, in response to receiving the update message indicating the successful performance of the second service by the service 116, the monitor manager component 120, employing a status component 206 and the monitoring service record generator component 202, can update the processing state associated with the second service request in the second monitoring service record to indicate that the second service has been successfully performed by the service 116 and the second service request has been successfully fulfilled. For instance, the monitor manager component 120 can update the second monitoring service record to indicate a successful processing state with regard to the second service request, in response to receiving the update message indicating the successful performance of the second service by the service 116.

In some embodiments, the monitor manager component 120 can communicate an acknowledgement message to the service 114, via the associated device 104, to indicate, acknowledge, or notify that the update to the processing state associated with the second service request to indicate successful and timely performance of the second service of the second service request has been performed, as indicated at reference numeral 332 of the operational process 300. The acknowledgement message also can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

In an alternate scenario in which the service 116 has failed to perform the second service requested in the second service request, and in connection with the second service request, the service 114, via the device 104, can communicate a get status message (e.g., prior to expiration of the timeout period) to the service 116, via the device 106, to facilitate determining the status of the performance of the second service request, as indicated at reference numeral 334 of the operational process 300. The get status request message can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

In this example instance, in response to receiving the get status message, the service 116, via the device 106, can communicate a response message (e.g., prior to expiration of the timeout period) to the service 114, via the device 104, wherein the response message can indicate (e.g., timely indicate prior to expiration of the applicable timeout period) that the second service has failed to be successfully performed by the service 116, as indicated at reference numeral 336 of the operational process 300. The response message also can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

In response to the response message indicating the failure to successfully perform of the second service, the service 114, via the device 104, can communicate an update message to the monitor manager component 120, wherein the update message can indicate the failure to successfully perform the second service by the service 116, as indicated at reference numeral 338 of the operational process 300. The update message also can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

As indicated at reference numeral 340, in response to receiving the update message indicating the failure to successfully perform the second service by the service 116, the monitor manager component 120, employing the status component 206 and the monitoring service record generator component 202, can update the processing state associated with the second service request in the second monitoring service record to indicate that the second service has failed to be successfully performed by the service 116 and the second service request has not been successfully fulfilled. For instance, the monitor manager component 120 can update the second monitoring service record to indicate a failure processing state with regard to the second service request, in response to receiving the update message indicating the failure to successfully perform the second service by the service 116.

In certain embodiments, the monitor manager component 120 can communicate an acknowledgement message to the service 114, via the associated device 104, to indicate, acknowledge, or notify that the update to the processing state associated with the second service request to indicate the failure to successfully perform the second service of the second service request by the service 116, as indicated at reference numeral 342 of the operational process 300. The acknowledgement message also can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

In some embodiments, in response to determining that there has been a failure of the service 116 to perform the second service requested in the second service request (and/or determining that one or more previous failures of the service 116 to perform the second service or other services in response to other service requests has or have occurred), the monitor manager component 120 can request a mitigation component 208 of or associated with the monitor manager component 120 to perform a mitigation service in connection with the failure of the service 116 to perform the second service, as indicated at reference numeral 344 of the operational process 300. Such mitigation request to the mitigation component 208 also can comprise other information, such as the correlation identifier associated with the task and/or the service 112, the second monitoring service record identifier associated with the second monitoring service record, the second service identifier associated with the service 114, the third service identifier associated with the service 116, and/or other desired information relating to the second service request.

In certain embodiments, the mitigation request can be more in the form of a notification to the mitigation component 208 that there has been a failure of the service 116 to perform the second service requested in the second service request. The monitor manager component 120 can request that the mitigation component 208 determine whether a mitigation action is to be performed in response to such failure(s) of the service 116 to perform the second service or other requested service(s) to mitigate such failure(s) and/or mitigate future failures to perform services by the service 116, based at least in part on a result of determining whether a mitigation condition for initiating performance of a mitigation action has been satisfied (e.g., met), such as described herein. If the mitigation component 208 determines that the mitigation condition has been satisfied, and a mitigation action is to be performed, the mitigation component 208 can determine a desired mitigation action that can be performed to mitigate such failure(s) and/or mitigate future failures to perform services by the service 116, such as more fully described herein.

In other embodiments, before sending a mitigation request to the mitigation component 208, the monitor manager component 120 can determine whether a particular mitigation condition for initiating or requesting mitigation has been satisfied (e.g., met). If such particular mitigation condition is determined to be satisfied, the monitor manager component 120 can send the mitigation request to the mitigation component 208; and if such particular mitigation condition is determined to not be satisfied, the monitor manager component 120 can determine that no mitigation request is to be sent to the mitigation component 208 in connection with the service failure, at least at that time.

In certain embodiments, as indicated at reference numeral 346 of the example operational process 300, in response to the request to the mitigation component 208, the mitigation component 208 can communicate an acknowledgement message to the monitor manager component 120 to indicate, acknowledge, or notify that the mitigation request has been received in connection with the failure of the service 116 to perform the second service of the second service request (and/or the other failure(s) of the service 116 to perform services). The acknowledgement message also can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

In still another alternate scenario with regard to a timeout condition associated with the second service request, based at least in part on the monitoring of the second service request indicating that no success or failure response message has been timely received by the service 114 from the service 116 before the expiration of the timeout period associated with (e.g., applicable to) the second service request, the monitor manager component 120, employing the monitor component 204, can detect, determine, or identify that the timeout condition has occurred without a success or failure response message being received by the service 114 from the service 116, and the monitor manager component 120, employing the status component 206 and the monitoring service record generator component 202, can update (e.g., modify) the second monitoring service record to indicate that the timeout condition has occurred without a success or failure response message being received by the service 114 from the service 116, as indicated at reference numeral 348 of the example operational process.

In some embodiments, in response to determining that there the timeout condition has occurred with regard to the second service request (and/or determining that one or more previous timeout conditions associated with the service 116 has or have occurred with regard to performing the second service or other services in response to other service requests), the monitor manager component 120 can request a mitigation component 208 of or associated with the monitor manager component 120 to perform a mitigation service in connection with the occurrence of the timeout condition with regard to the service 116 performing the second service, as indicated at reference numeral 350 of the operational process 300. Such mitigation request to the mitigation component 208 also can comprise other information, such as the correlation identifier associated with the task and/or the service 112, the second monitoring service record identifier associated with the second monitoring service record, the second service identifier associated with the service 114, the third service identifier associated with the service 116, and/or other desired information relating to the second service request.

In certain embodiments, the mitigation request can be more in the form of a notification to the mitigation component 208 that the timeout condition has occurred with regard to performance of the second service by the service 116 in connection with the second service request (and/or one or more other timeout conditions have previously occurred with regard to one or more previous service requests). The monitor manager component 120 can request that the mitigation component 208 determine whether a mitigation action is to be performed in response to such timeout condition(s) occurring, based at least in part on a result of determining whether a mitigation condition for initiating performance of a mitigation action has been satisfied (e.g., met), such as described herein. If the mitigation component 208 determines that the mitigation condition has been satisfied, and a mitigation action is to be performed, the mitigation component 208 can determine a desired mitigation action that can be performed to mitigate such timeout condition(s) and/or mitigate future timeout conditions in connection with performance of services by the service 116, such as more fully described herein.

In other embodiments, before sending a mitigation request to the mitigation component 208 in connection with the occurrence of the timeout condition associated with the second service request, the monitor manager component 120 can determine whether a particular mitigation condition for initiating or requesting mitigation has been satisfied (e.g., met). If such particular mitigation condition is determined to be satisfied, the monitor manager component 120 can send the mitigation request to the mitigation component 208; and if such particular mitigation condition is determined to not be satisfied, the monitor manager component 120 can determine that no mitigation request is to be sent to the mitigation component 208 in connection with the occurrence of the timeout condition associated with the second service request, at least at that time.

As indicated at reference numeral 352, in response to the request to the mitigation component 208, the mitigation component 208 can communicate an acknowledgement message to the monitor manager component 120 to indicate, acknowledge, or notify that the mitigation request has been received in connection with the occurrence of the timeout condition associated with the second service request (and/or the other timeout condition(s) associated with the service 116). The acknowledgement message also can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

As indicated at reference numeral 354, in connection with the first service request, the service 112, via the device 102, can communicate a get status message to the service 114, via the device 104, to facilitate determining the status of the performance of the first service request. The get status request message can comprise the correlation identifier associated with the task and/or the service 112, the first monitoring service record identifier associated with the first monitoring service record, the first service identifier associated with the service 112, the second service identifier associated with the service 114, and/or other desired information relating to the second service request.

As indicated at reference numeral 356, in this example instance, in response to receiving the get status message, the service 114, via the device 104, can communicate a response message to the service 112, via the device 102, wherein the response message can indicate the current status of the performance of the first service by the service 114. In this example instance, the status may be that the first service has failed to be successfully performed by the service 114, due at least in part to the service 116 not timely performing the second service. The response message also can comprise the correlation identifier associated with the task and/or the service 112, the first monitoring service record identifier associated with the first monitoring service record, the first service identifier associated with the service 112, the second service identifier associated with the service 114, and/or other desired information relating to the second service request.

It is to be appreciated and understood that, for reasons of brevity and clarity, the example operational process 300 only involves the service 112 invoking one service, the service 114, and the service 114 invoking one service, the service 116, in connection with performance of a task. However, depending on the task or transaction, and the types of services desired to perform the task or transaction (e.g., perform sub-tasks of the task or transaction), the service 112 can invoke one or more other services (e.g., service 114 and/or one or more other services), the service 114 can invoke one or more other services (e.g., service 116 and/or one or more other services), the service 116 can invoke one or more other services (e.g., service 118 and/or one or more other services), the service 118 can invoke one or more other services, and/or another service(s) can invoke one or more other services, in connection with performance of the task or transaction.

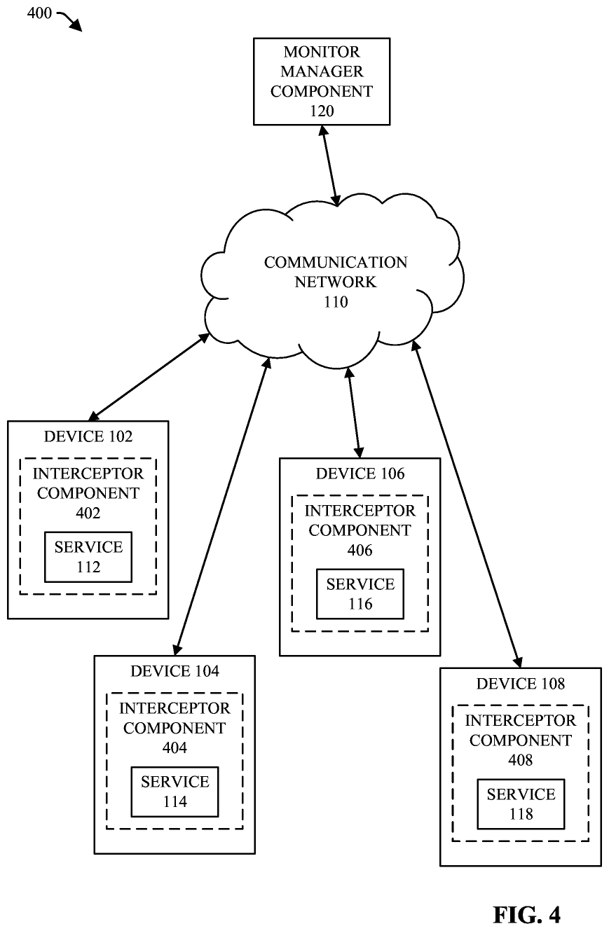

Referring to FIG. 4 (along with FIG. 2), FIG. 4 illustrates a block diagram of a non-limiting example system 400 that can desirably (e.g., efficiently, suitably, enhancedly, or optimally) perform and manage automated monitoring of tasks, transactions, and operations, including automated long duration monitoring of tasks, transactions, and operations, utilizing interceptor components to facilitate such monitoring, in accordance with various aspects and embodiments of the disclosed subject matter. The system 400 can comprise a group of devices, which can comprise a desired number of devices, such as device 102, device 104, device 106, device 108, and/or one or more other devices. At desired times, the devices (e.g., 102, 104, 106, and/or 108) can be associated with (e.g., communicatively connected) a communication network 110 to facilitate communication of data between a device (e.g., 102, 104, 106, or 108) and the communication network 110, and/or facilitate communication of data between the devices via the communication network 110.

The respective devices (e.g., 102, 104, 106, and/or 108) can comprise, employ, and/or access data processing resources (e.g., processor(s)), storage resources (e.g., data store(s)), applications, and/or other resources that can enable the respective devices to each perform one or more respective services (e.g., microservices or other types of services), such as service 112, service 114, service 116, and service 118. in accordance with various embodiments, the system 400 also can comprise the monitor manager component 120 that can desirably monitor and/or track status and/or progress of the respective tasks, transactions, and/or operations associated with (e.g., performed by) the respective services (e.g., 112, 114, 116, and/or 118), such as described herein. The monitor manager component 120 can be associated with (e.g., communicatively connected to) the communication network 110 and/or the respective devices (e.g., 102, 104, 106, and/or 108), and/or the respective associated services (e.g., 112, 114, 116, and/or 118) to facilitate the monitoring (e.g., automated long duration monitoring) of the respective tasks, transactions, and/or operations associated with the respective services, such as described herein.

In accordance with various embodiments, the system 400 also can comprise interceptor components, such as interceptor components 402, 404, 406, and 408, that can be associated with the respective services 112, 114, 116, and/or 118 and/or associated devices 102, 104, 106, and/or 108, and also can be associated with the monitor manager component 120. The interceptor components (e.g., 402, 404, 406, and/or 408) can be employed with the services (e.g., 112, 114, 116, and/or 118) to facilitate monitoring of service requests and messages (e.g., service request messages, response messages, update messages, or other messages) associated with the service requests. Interceptor components (e.g., long duration monitoring interceptor components) can be viewed as inbound message and outbound messages handlers (e.g., managers) or filters. Some programming languages and programming models can allow handlers or filters that can be chained or inserted into an inbound and outbound message processing path, such as an inbound and outbound message processing path associated with the service (e.g., 112, 114, 116, or 118). The system 400 can desirably leverage these programming models to implement long duration monitoring interceptor components (e.g., 402, 404, 406, and/or 408) as handlers or filters.

While, in the system 400, each service (e.g., 112, 114, 116, or 118) is depicted as being associated with one interceptor component (e.g., 402, 404, 406, or 408), a service can be associated with more than one interceptor component. For instance, a service (e.g., 112) can be associated with one or more respective interceptor components associated with one or more respective programming languages, wherein there can be one interceptor component per programming language. In certain embodiments, the system 400 can implement a containerized application deployment environment, wherein the system 400, including the monitor manager component 120, the services (e.g., 112, 114, 116, and/or 118), and the interceptor components (e.g., 402, 404, 406, and/or 408) can be programming language agnostic, and the system 400 can leverage a programming language agnostic way to inject the interceptor components.

With further regard to interceptor components (e.g., 402, 404, 406, and/or 408) in a containerized application deployment environment (e.g., Kubernetes deployment environment), the system 400 can leverage sidecars to host the interceptor components (e.g., long duration monitoring interceptor components). For instance, the system 400 can provide monitoring instrumentation automation using sidecar injection in an application pod. Monitoring agents can be injected as a sidecar in an application pod, which can be monitored. A monitoring agent sidecar (e.g., a monitoring service proxy sidecar) can be injected during the time of pod initialization. This sidecar can intercept the outgoing traffic (e.g., outgoing messages or other outgoing data traffic) from the application container to an envoy-proxy container and can update the monitor manager component 120 about the outgoing traffic and/or associated task or transaction. This customized instrumentation of monitoring agent sidecars into service running into multiple clusters can allow the monitor manager component 120 to monitor and track long running tasks or transactions. The system 400 can implement the interceptor components (e.g., 402, 404, 406, and/or 408) in the containerized application deployment environment, wherein such implementation can apply or utilize one or more desired protocols, such as, for example, hypertext transfer protocol (HTTP)/1.1 protocol, remote procedure call (RPC) (e.g., gRPC), HTTP/2, WebSocket protocol, event message protocols, and/or other desired protocols.

The interceptor components (e.g., 402, 404, 406, and/or 408) can comprise or employ processing resources (e.g., a processor, or a virtual machine or processor) to facilitate performing the various operations of the interceptor components. The interceptor components (e.g., 402, 404, 406, and/or 408) also can desirably store (e.g., save) or persist information relating to service requests, response messages responsive to service requests, processing state information associated with service requests, response timeout information relating to response timeout events that may occur, and/or other desired information relating to tasks, transactions, service requests, or messages relating thereto in storage (e.g., a data store) of or associated with the interceptor components.

In some embodiments, an interceptor component (e.g., 402, 404, 406, or 408) does not have to save the state of an incoming service request message for any subsequent response messages relating to the service request, and does not have to access state information relating to the service request from another storage location (e.g., an external storage location). In certain embodiments, the interceptor component (e.g., 402, 404, 406, or 408) determine, deduce, or infer state information associated with a service request from header information in service request message headers and/or header information in response message headers. For instance, the interceptor component (e.g., 402, 404, 406, or 408) can deduce or determine whether and what to instrument in connection with a service request by examining the header information in service request message headers (e.g., HTTP or other type of header in a service request message) and/or the header information in response message headers This can eliminate the need for the interceptor component to utilize local state storage to store state information relating to service requests. The use of interceptor components (e.g., 402, 404, 406, and/or 408) also can eliminate having to use manual instrumentation in the monitoring of tasks and transactions. The instrumentation via the interceptor components (e.g., 402, 404, 406, and/or 408) can automate instrumentations without touching or interacting with service (e.g., microservice) source code, and the instruments in the interceptor components can be independent from choice of microservice programming languages.

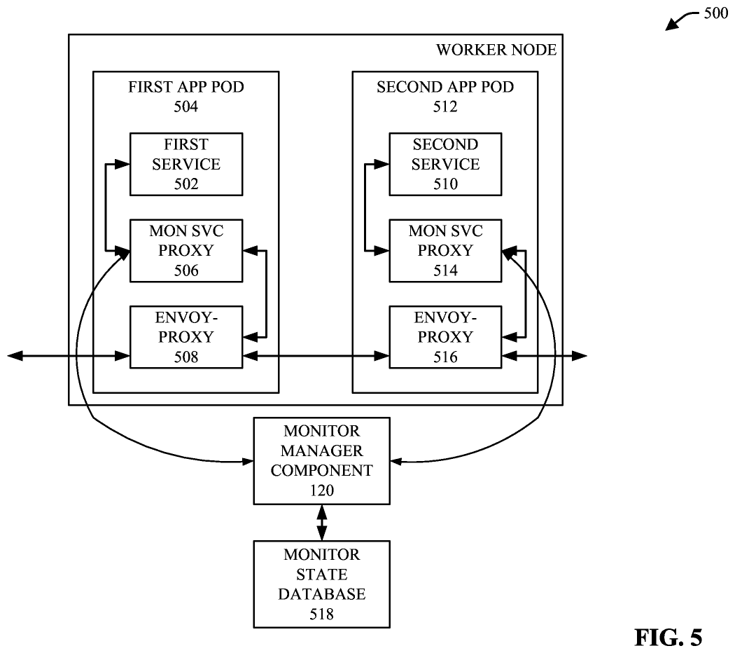

Turning to FIG. 5 (along with FIG. 4), FIG. 5 depicts a block diagram of a non-limiting example monitoring instrumentation automation using sidecar injection 500 where a sidecar can be utilized to host an interceptor component (e.g., a long duration monitoring interceptor component), in accordance with the various aspects and embodiments of the disclosed subject matter. The example monitoring instrumentation automation using sidecar injection 500 can involve monitoring sidecar injection and message routing. As depicted in the example monitoring instrumentation automation using sidecar injection 500, instrumentation by sidecar injection can operate by injecting a monitoring service proxy sidecar in an application pod, along with the application container and envoy-proxy container (e.g., Istio envoy-proxy container).

For instance, with regard to a first service 502, the first service 502 can be part of or associated with a first application pod (FIRST APP POD) 504. A monitoring service proxy sidecar (MON SVC PROXY) 506 and envoy-proxy container (ENVOY-PROXY) 508 can be injected into the first application pod 504, along with an application container. With regard to a second service 510, the second service 510 can be part of or associated with a second application pod (SECOND APP POD) 512. A monitoring service proxy sidecar 514 and envoy-proxy container 516 can be injected into the second application pod 512, along with an application container.

The monitoring service proxy sidecar (e.g., 506) associated with a service (e.g., 502) can intercept outgoing request messages (e.g., outgoing service request messages) and incoming response messages between application containers and envoy-proxy containers (e.g., envoy-proxy containers 508 and 516). The monitoring service proxy sidecar (e.g., 506) can obtain and/or gather (e.g., aggregate) information about the request and response messages, can modify message headers associated with messages when desired (e.g., wanted, needed, or suitable), for example, by adding processing extensions (e.g., header processing extensions), and can send the information regarding the request and response messages to the monitor manager component 120 (e.g., the monitoring service of the monitor manager component 120). By adding header processing extensions, the disclosed instrumentation approach employed by the interceptor components and monitoring service proxy sidecars can be agnostic with respect to request processing protocols, and the disclosed instrumentation approach can be agnostic to programming languages used to create the associated service, as it can be performed at the network layer. The envoy-proxy container (e.g., 508) can obtain the data traffic (e.g., message traffic) from the monitoring service proxy sidecar (e.g., 506) and can forward the data traffic to its counterpart envoy-proxy container (e.g., 516) in the other application pod (e.g., second application pod 512).

The monitor manager component 120 can receive the messages from application pods (e.g., 504 and 512) that are instrumented with monitoring service proxy sidecars (e.g., 506 and 514), and can track a long running task or transaction, which can span multiple clusters (e.g., multiple clusters of nodes and/or services), as each service instrumented can send (e.g., communicate) a traffic update to the monitor manager component 120. The tracking of outgoing service request messages, the existence of response messages (e.g., associated with or responsive to the service request messages), and response timeout events (e.g., the occurrence of a timeout condition associated with a service request) can signify some of the uniqueness of the disclosed long duration task or transaction sidecar injection message monitoring techniques, functionality, and tools over existing monitoring tools. The long duration task or transaction monitoring can desirably track tasks or transactions (e.g., long duration tasks or transactions) by tracking task or transaction message flow (e.g., service request messages, response messages, update messages, other messages, and/or response timeout events) end-to-end, the eventual task or transaction success or failure (e.g., failure to successfully complete), and/or reasons or conditions for unsuccessful completion of services or sub-tasks requested in service requests by tracking the respective processing states associated with respective service requests using the monitoring service of the monitor manager component 120 and monitoring state database 518 (e.g., persistent monitoring state database stored in a data store) of or associated with the monitor manager component 120.

In some embodiments, if and as desired, monitoring service proxy sidecars can be injected only into the services that have to be monitored, rather than having to use sidecars to monitor all services running namespace. The disclosed approach for using the interceptor components (e.g., 402, 404, 406, and/or 408) described herein also does not require running of any node agents in order to perform or facilitate the monitoring of service requests and responses to such requests.

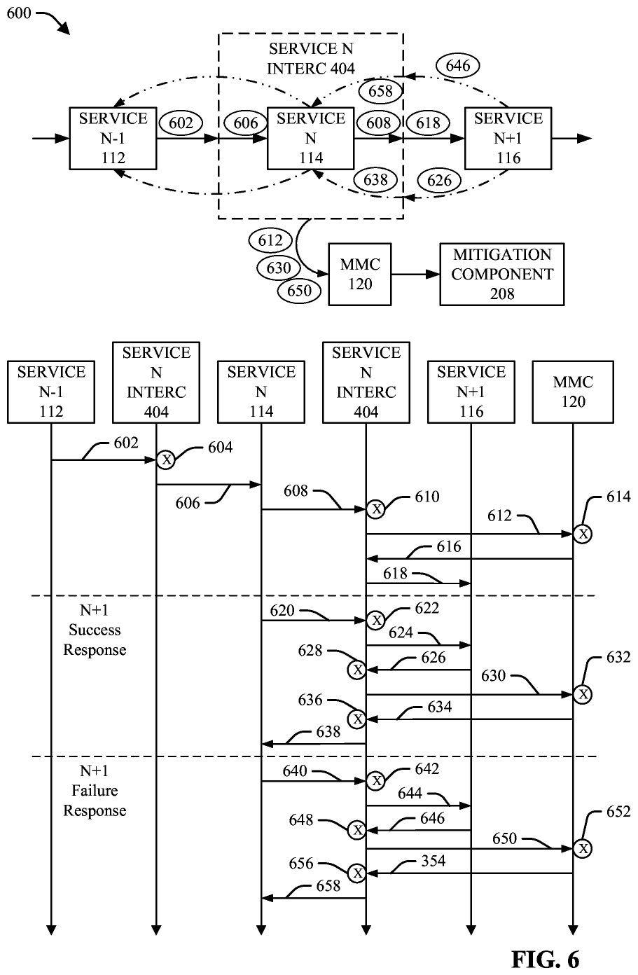

Referring to FIG. 6 (along with FIGS. 1, 2, 4, and 5), FIG. 6 depicts a block diagram of a non-limiting example operational process 600 (e.g., an operational sequence) for monitoring (e.g., long duration monitoring) of service requests associated with a task across multiple services where an intercept component can be employed in connection with a service, in accordance with the various aspects and embodiments of the disclosed subject matter. The example operational process 600 can involve multiple services, including service 112 (also referred to herein and in the drawings as service N−1 112), service 114 (also referred to herein and in the drawings as service N 114), and service 116 (also referred to herein and in the drawings as service N+1 116), wherein, in connection with a task to be performed, the service 112 can invoke the service 114 to perform a first service, and, in connection with the service 114 performing the first service, the service 114 can invoke the service 116 to perform a second service. As part of the example operational process 600, the monitor manager component 120 can monitor service requests associated with the task, and associated messages and events, across these multiple services (e.g., 112, 114, 116), wherein the interceptor component 404 (also referred to SERVICE N INTERC) associated with the service 114 can facilitate the monitoring of some of the service requests, messages, and/or events associated with the task at least with respect to the service 114.

The service 112 can desire to, or can be engaged to, perform the task (e.g., task associated with or involving a transaction, or other type of task). In connection with performance of the task, the service 112 can desire to invoke the service 114, via a first service request, to perform the first service to facilitate performance of the task. As the example operational process 600 is intended to present or depict various aspects relating to employing the interceptor component 404 with the service 114 in connection with monitoring (e.g., long duration monitoring) of service requests, messages, and/or events associated with the task, for reasons of brevity and clarity, certain other operations associated with the task may be omitted or only generally described. It is to be appreciated and understood that, in some embodiments, the service 112 can be associated with the interceptor component 402, and the service 116 can be associated with the interceptor component 406, although, for reasons of brevity and clarity, the interceptor component 402 and the interceptor component 406 are not shown in FIG. 6 and operations associated with the interceptor component 402 and the interceptor component 406 are not explicitly described herein. However, the techniques, aspects, and operations described herein with regard to the interceptor component 404 associated with the service 114 can be extended to the interceptor component 402, the interceptor component 406, and/or other interceptor components associated with other services, in accordance with various aspects and embodiments of the disclosed subject matter.

It also is to be appreciated and understood that, for reasons of brevity and clarity, the example operational process 600 only involves the service 112 invoking one service, the service 114, and the service 114 invoking one service, the service 116, in connection with performance of a task. However, depending on the task or transaction, and the types of services desired to perform the task or transaction (e.g., perform sub-tasks of the task or transaction), the service 112 can invoke one or more other services (e.g., service 114 and/or one or more other services), the service 114 can invoke one or more other services (e.g., service 116 and/or one or more other services), the service 116 can invoke one or more other services (e.g., service 118 and/or one or more other services), the service 118 can invoke one or more other services, and/or another service(s) can invoke one or more other services, in connection with performance of the task or transaction.

As indicated at reference numeral 602 of the operational process 600, the service 112 (e.g., via the device 102) can communicate a first service request message to the service 114 (e.g., via the device 104) to request that the service 114 perform the first service. In some embodiments, the first service to be performed by the service 114 can be an asynchronous service. While not shown in the example operational process 600 for reasons of brevity and clarity, prior to communicating the first service request message to the service 114, the service 112 or associated interceptor component 402 can communicate with the monitor manager component 120 to have a first monitoring service record created in connection with the task and the invoking of the service 114 by the service 112 to perform the first service, such as or similar to as described herein. For example, the interceptor component 402 can intercept the first service request message output from the first service (e.g., via the device 102), and the interceptor component 402 can communicate a request to have a first monitoring service record created for the first service request. As part of or in connection with the request, the interceptor component 402 can provide service request-related information, including a first service identifier that can identify the service 112 that is issuing the first service request, a second service identifier that can identify the service 114 that is to perform the first service, a timeout period indicating an amount of time that the service 114 can have to perform the first service, information that can inform or request the monitor manager component 120 to update the processing state associated with the first service request if and when a response message indicating a success in performing the first service or a failure to perform the first service is received from the service 114, and/or other service request-related information associated with the first service request message.

As a result, the monitor manager component 120 can create the first monitoring service record, which can comprise a correlation identifier associated with the task and/or the service 112, a first monitoring service record identifier associated with the first monitoring service record, a first service identifier associated with the service 112, a second service identifier associated with the service 114, a timeout period indicating an amount of time that the service 114 can have to perform the first service, information that can inform or request the monitor manager component 120 to update the processing state associated with the first service request if and when a response message indicating a success in performing the first service or a failure to perform the first service is received from the service 114, and/or other desired information relating to the first service request. Accordingly, the first service request message forwarded by the interceptor component 402 to the service 114 (e.g., the device 104 associated with the service 114) can comprise the first monitoring service record identifier, the correlation identifier associated with the task and/or the service 112, the first service identifier associated with the service 112, the second service identifier associated with the service 114, and/or other desired information relating to the first service request.

With further reference to the operational process 600, as indicated at reference numeral 604 of the operational process 600, the interceptor component 404 associated with the service 114 can intercept the first service request message that can be incoming to the service 114 from the service 112 (e.g., via the interceptor component 402 and/or the device 102 associated with the service 112). As indicated at reference numeral 606, the interceptor component 404 associated with the service 114 can forward the first service request message to the service 114.

In response to receiving the first service request message, the service 114 can recognize or determine that, in connection with the service 114 performing the first service, it can be desirable (e.g., wanted, needed, or otherwise desired) for the service 114 to invoke the service 116 to perform a second service (e.g., to facilitate the performing of the first service). As indicated at reference numeral 608 of the operational process 600, the service 114 (e.g., via the device 104) can communicate a second service request message to the service 116, wherein the second service request message can request that the service 116 perform the second service in connection with the task and/or to facilitate performance of the first service by the service 114. In addition to specifying the second service requested to be performed, the second service request message can comprise the first monitoring service record identifier, the correlation identifier associated with the task and/or the service 112, the first service identifier associated with the service 112, the second service identifier associated with the service 114, a third service identifier associated with the service 116 to be invoked by the second service request message, and/or other desired information relating to the second service request message.

As indicated at reference numeral 610 of the operational process 600, the interceptor component 404 associated with the service 114 can intercept the second service request message that can be outgoing from the service 114 to the service 116. In connection with the service 114 issuing a second service request to the service 116, the interceptor component 404 can communicate a request to have a second monitoring service record created for the second service request, as indicated at reference numeral 612 of the operational process 600. As part of or in connection with the request to have the second monitoring service record created, the interceptor component 404 can provide service request-related information, including the correlation identifier associated with the task and/or the service 112, the second service identifier that can identify the service 114 that is issuing the second service request, the third service identifier that can identify the service 116 that is to perform the second service, a timeout period indicating an amount of time that the service 116 can have to perform the second service, information that can inform or request the monitor manager component 120 to update the processing state associated with the second service request if and when a response message indicating a success in performing the second service or a failure to perform the second service is received from the service 116, and/or other service request-related information associated with the second service request.

As indicated at reference numeral 614, the monitoring service record generator component 202 can generate a second monitoring service record relating to the second service request. The second monitoring service record can comprise a second monitoring service record identifier that can identify the second monitoring service record, the correlation identifier associated with the task and/or the service 112, the second service identifier associated with the service 114, the third service identifier associated with the service 116, the timeout period associated with (e.g., applicable to) the second service request, an update indicator that can indicate that the processing state is to be updated in the second monitoring service record if and when a response message is received from the service 116, and/or other service request-related information associated with the second service request. As indicated at reference numeral 616 of the operational process 600, the monitor manager component 120 can communicate an acknowledgement message to the interceptor component 404 associated with the service 114, wherein the acknowledgement message can indicate that the second monitoring service record was created, and/or can comprise the second monitoring service record identifier, the correlation identifier associated with the task, and/or other desired information relating to the task.

As indicated at reference numeral 618 of the operational process 600, the interceptor component 404 can communicate (e.g., forward) the second service request message (or a version of the second service request message updated based at least in part on information, such as the second monitoring service record identifier, received in the acknowledgement message) to the service 116, via the device 106, to request that the service 116 perform the second service. In some embodiments, the second service to be performed by the service 116 can be an asynchronous service. The second service request message (e.g., updated second service request message) can comprise the second monitoring service record identifier, the correlation identifier associated with the task and/or the service 112, the second service identifier associated with the service 114, the third identifier associated with the third service 116, and/or other desired information relating to the second service request.

The monitor manager component 120, employing the monitor component 204, can monitor and/or track the service requests, including the first service request and the second service request, associated with the task to facilitate determining whether the first service request and/or the second service request have been successfully performed or have failed to be performed, and/or whether the respective timeout periods associated with the first service request and/or second service request has or have expired without a response or update message being received. In some embodiments, to facilitate obtaining or determining a status of a service request, a requesting service (e.g., service 114) that issued the service request (e.g., second service request) can invoke a get status (e.g., obtain status) with regard to the service request, such as described herein. In other embodiments, the event notification approach can be employed by the services (e.g., 112, 114, 116) such as described herein.

For instance, with regard to the example operational process 600, which can employ exemplary get status requests, there can be different scenarios in which the second service can be successfully performed by the service 116, the second service can fail to be performed by the service 116, or the applicable timeout period associated with the second service request can expire without a response or update message being received from the service 116. In that regard, in an example instance, with regard to a scenario in which the second service can be successfully and timely performed by the service 116, and in connection with the second service request, the service 114 (e.g., via the device 104) can communicate a get status message (e.g., prior to expiration of the timeout period) to (e.g., destined to) the service 116 (e.g., via the device 106) to facilitate determining the status of the performance of the second service request, as indicated at reference numeral 620 of the operational process 600. The get status request message can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

As indicated at reference numeral 622 of the operational process 600, the interceptor component 404 associated with the service 114 can intercept the get status request message that can be outgoing from the service 114 to the service 116. As indicated at reference numeral 624, the interceptor component 404 can forward (e.g., communicate) the get status request message to the service 116 (e.g., via the device 106 and/or interceptor component 406 associated with the service 116).

In this example instance, in response to receiving the get status message, the service 116 (e.g., via the device 106 and/or the interceptor component 406 associated with the service 116) can communicate a response message (e.g., prior to expiration of the timeout period) to (e.g., destined to) the service 114 or associated interceptor component 404, wherein the response message can indicate that the second service has been successfully performed by the service 116, as indicated at reference numeral 626 of the operational process 600. The response message can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

As indicated at reference numeral 628, the interceptor component 404 can intercept the response message destined to the service 114. In response to the response message indicating successful performance of the second service, the interceptor component 404 can communicate an update message to the monitor manager component 120, wherein the update message can indicate the successful performance of the second service by the service 116, as indicated at reference numeral 630 of the operational process 600. The update message also can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

As indicated at reference numeral 632, in response to receiving the update message indicating the successful performance of the second service by the service 116, the monitor manager component 120, employing the status component 206 and the monitoring service record generator component 202, can update the processing state associated with the second service request in the second monitoring service record to indicate that the second service has been successfully performed by the service 116 and the second service request has been successfully fulfilled. For instance, the monitor manager component 120 can update the second monitoring service record to indicate a successful processing state with regard to the second service request, in response to receiving the update message indicating the successful performance of the second service by the service 116.

In some embodiments, the monitor manager component 120 can communicate an acknowledgement message to (e.g., destined to) the service 114 and/or the interceptor component 404 to indicate, acknowledge, or notify that the update to the processing state associated with the second service request to indicate successful and timely performance of the second service of the second service request has been performed, as indicated at reference numeral 634 of the operational process 600. The acknowledgement message also can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

As indicated at reference numeral 636, the interceptor component 404 can intercept the acknowledgement message. As indicated at reference numeral 638, the interceptor component 404 can forward the acknowledgement message to the service 114 (e.g., via the device 104).

In an alternate scenario in which the service 116 has failed to perform the second service requested in the second service request, and in connection with the second service request, the service 114 (e.g., via the device 104 and/or interceptor component 404 associated with the service 114) can communicate a get status message (e.g., prior to expiration of the timeout period) to (e.g., destined to) the service 116 to facilitate determining the status of the performance of the second service request, as indicated at reference numeral 640 of the operational process 600. The get status request message can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

As indicated at reference numeral 642 of the operational process 600, the interceptor component 404 associated with the service 114 can intercept the get status request message that can be outgoing from the service 114 to the service 116. As indicated at reference numeral 644, the interceptor component 404 can forward the get status request message to the service 116 (e.g., via the device 106 and/or interceptor component 406 associated with the service 116).

In this example instance, in response to receiving the get status message, the service 116 (e.g., via the device 106 and/or interceptor component 406 associated with the service 116) can communicate a response message (e.g., prior to expiration of the timeout period) to (e.g., destined to) the service 114 or associated interceptor component 404, wherein the response message can indicate (e.g., timely indicate prior to expiration of the applicable timeout period) that the second service has failed to be successfully performed by the service 116, as indicated at reference numeral 646 of the operational process 600. The response message also can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

As indicated at reference numeral 648, the interceptor component 404 can intercept the response message destined to the service 114. In response to the response message indicating that the service 116 has failed to perform the second service, the interceptor component 404 can communicate an update message to the monitor manager component 120, wherein the update message can indicate that the service 116 has failed to perform the second service, as indicated at reference numeral 650 of the operational process 600. The update message also can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

As indicated at reference numeral 652, in response to receiving the update message indicating the failure to successfully perform the second service by the service 116, the monitor manager component 120, employing the status component 206 and the monitoring service record generator component 202, can update the processing state associated with the second service request in the second monitoring service record to indicate that the second service has failed to be successfully performed by the service 116 and the second service request has not been successfully fulfilled. For instance, the monitor manager component 120 can update the second monitoring service record to indicate a failure processing state with regard to the second service request, in response to receiving the update message indicating the failure to successfully perform the second service by the service 116.

In certain embodiments, the monitor manager component 120 can communicate an acknowledgement message to (e.g., destined to) the service 114 or associated interceptor component 404 to indicate, acknowledge, or notify that the update to the processing state associated with the second service request to indicate the failure to successfully perform the second service of the second service request by the service 116, as indicated at reference numeral 654 of the operational process 600. The acknowledgement message also can comprise the correlation identifier associated with the task and/or the service 112, the second monitoring service record identifier associated with the second monitoring service record, the second service identifier associated with the service 114, the third service identifier associated with the service 116, and/or other desired information relating to the second service request.

As indicated at reference numeral 656, the interceptor component 404 can intercept the acknowledgement message destined to the service 114 from the monitor manager component 120. As indicated at reference numeral 658, the interceptor component 404 can forward the acknowledgement message to the service 114 (e.g., via the device 104).

In accordance with various embodiments, in response to determining that the service 116 failed to perform the second service or a timeout condition (e.g., response timeout event) has occurred with regard to the second service, the monitor manager component 120 can determine whether to engage the mitigation component 208 (e.g., to send a mitigation request to the mitigation component 208) to perform a mitigation service, based at least in part on a result of determining whether a particular mitigation condition or criteria has been satisfied, indicating that the mitigation component 208 is to perform the mitigation service and/or determine a mitigation action to mitigate the service failure or future service failures, or mitigate the timeout condition or future occurrences of a timeout condition associated with the service 116 or the second service in particular, such as described herein. If the mitigation component 208 is engaged to perform the mitigation service, the mitigation component 208 can determine a mitigation action to mitigate the service failure or future service failures, or mitigate the timeout condition or future occurrences of a timeout condition associated with the service 116 or the second service based at least in part on the results of analyzing information relating to the current task and/or associated services or information relating to previous tasks and/or services, such as described herein.

With further regard to FIG. 2, in some embodiments, the monitor manager component 120 can comprise a presentation component 210 that can present information relating to tasks and/or services to a user associated with the monitor manager component 120 (e.g., via an interface(s) of the presentation component 210) and/or to a device(s) (e.g., 102, 104, 106, and/or 108) associated with a service(s) (e.g., 112, 114, 116, and/or 118) and/or user(s). The information relating to tasks and/or services can comprise respective service request statuses associated with respective service requests (e.g., processing states associated with service requests), an overall status associated with a task, a service failure, if any service failure occurs, a timeout condition associated with a service, if any timeout condition has occurred, and/or other desired information relating to the task and/or associated services. The presentation component 210 also can provide update information relating to or regarding the task or an associated service to the user associated with the monitor manager component 120 and/or to the device(s) (e.g., 102, 104, 106, and/or 108) associated with the service(s) (e.g., 112, 114, 116, and/or 118) and/or user(s). If a mitigation action has been determined or has been performed, or to facilitate the performance of a mitigation action, the presentation component 210 can present (e.g., communicate) information relating to the mitigation action to the user associated with the monitor manager component 120 and/or to the device(s) (e.g., 102, 104, 106, and/or 108) associated with the service(s) (e.g., 112, 114, 116, and/or 118) and/or user(s).

In certain embodiments, the monitor manager component 120 can comprise an artificial intelligence (AI) component 212 that can employ, build (e.g., construct, create, and/or train), and/or import AI and/or ML models, neural networks (e.g., trained neural networks), and/or graph mining, and/or can employ AI and/or ML techniques and algorithms, to render and/or generate predictions, inferences, calculations, prognostications, estimates, derivations, forecasts, detections, and/or computations that can facilitate determining whether a mitigation action is to be performed, determining a pattern in data relating to tasks, transactions, or services to facilitate determining what is causing service request failures or timeout conditions associated with service requests, determining a pattern in data relating to tasks, transactions, or services to facilitate determining mitigation actions that can be performed to mitigate service request failures or timeout conditions associated with service requests, determining an adjustment that can be made to a service to facilitate mitigating service request failures or timeout conditions associated with service requests, determining an adjustment that can be made to a timeout period to facilitate mitigating timeout conditions associated with service requests, and/or making other desired determinations, including the determinations described herein, and/or automating one or more functions or features of the disclosed subject matter (e.g., automating one or more functions or features of or associated with the monitor manager component 120, a service, a device, or component), as more fully described herein.

The AI component 212 can employ various AI-based or ML-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 212 can examine the entirety or a subset of the data (e.g., data associated with tasks, services, applications, devices, or users; and/or other data) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

The monitor manager component 120 can comprise a processor component 214 that can work in conjunction with the other components (e.g., monitoring service record generator component 202, monitor component 204, status component 206, mitigation component 208, presentation component 210, AI component 212, data store 216, and/or other component) to facilitate performing the various functions of the monitor manager component 120. The processor component 214 can employ one or more processors (e.g., one or more CPUs), microprocessors, or controllers that can process information relating to tasks, transactions, services, service requests, monitor service records, processing states associated with service requests, service request failures, timeout conditions associated with service requests, files, mitigation actions, notifications, alarms, alerts, preferences (e.g., user or client preferences), applications, hash values, metadata, parameters, traffic flows, policies, defined monitoring management criteria, algorithms (e.g., monitoring management-related algorithms, hash algorithms, data compression algorithms, data decompression algorithms, and/or other algorithm), interfaces, protocols, tools, and/or other information, to facilitate operation of the monitor manager component 120, and control data flow between the monitor manager component 120 and/or other components (e.g., device, node, service, user, or other entity) associated with the monitor manager component 120.

The monitor manager component 120 also can comprise data store 216 that can store data structures (e.g., user data, metadata), code structure(s) (e.g., modules, objects, hashes, classes, procedures) or instructions, information relating to tasks, transactions, services, service requests, monitor service records, processing states associated with service requests, service request failures, timeout conditions associated with service requests, files, mitigation actions, notifications, alarms, alerts, preferences (e.g., user or client preferences), applications, hash values, metadata, parameters, traffic flows, policies, defined monitoring management criteria, algorithms (e.g., monitoring management-related algorithms, hash algorithms, data compression algorithms, data decompression algorithms, and/or other algorithm), interfaces, protocols, tools, and/or other information, to facilitate controlling or performing operations associated with the monitor manager component 120. The data store 216 can comprise volatile and/or non-volatile memory, such as described herein. In an aspect, the processor component 214 can be functionally coupled (e.g., through a memory bus) to the data store 216 in order to store and retrieve information desired to operate and/or confer functionality, at least in part, to the monitoring service record generator component 202, monitor component 204, status component 206, mitigation component 208, presentation component 210, AI component 212, processor component 214, data store 216, and/or other component of the monitor manager component 120, and/or substantially any other operational aspects of the monitor manager component 120.

It should be appreciated that the data store 216 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

With further regard to the mitigation component 208, in some embodiments, the mitigation component 208 can analyze information relating to one or more tasks (e.g., a current or most recent task or transaction and/or one or more previous tasks or transactions), services, service requests, one or more service request failures, one or more timeout conditions associated with one or more service requests, and/or other desired information to facilitate determining one or more mitigation actions that can be performed to mitigate any harm associated with a service request failure or mitigate the occurrence of future service request failures, or mitigate any harm associated with occurrence of a timeout condition associated with a service request or mitigate the occurrence of future timeout conditions associated with service requests. In some embodiments, the monitoring of the task and associated messages (e.g., service request messages, response, messages, update messages, or other messages) and events (e.g., response timeout events) by the monitor manager component 120 can produce (e.g., generate) a resulting request flow that can be in the form of a directed acyclic graph or other desired form. The monitor manager component 120 (e.g., mitigation component 208, AI component 212, or other component of the monitor manager component 120) can analyze the graph, and, based at least in part on the results of analyzing such graph, the monitor manager component 120 can determine which service caused a failure in the completion of a sub-task of the task and/or why there was such a failure, can determine which service caused an occurrence of a timeout condition associated with a service request, can determine whether a timeout period associated with a service request or service is too short or too long, and/or can make other determinations relating to issues that may arise in the performance of services and sub-tasks in connection with an overall task or transaction (e.g., a long duration task or transaction).

As an example of mitigation relating to a timeout condition, with regard to a timeout condition associated with a service request that has occurred in connection with a task or transaction and/or one or more previous timeout conditions that occurred with regard to one or more previous service requests, the mitigation component 208 can determine whether an adjustment is to be made to a timeout period associated with that type of service request and/or associated with the service that was performing the service request, and, if so, the amount or type of adjustment to be made to the timeout period (e.g., increase or decrease the time period by a certain time amount), based at least in part on the results of analyzing current information relating to the timeout condition and/or historical information relating to previous timeout conditions that occurred with regard to previous service requests and/or services, in accordance with the defined monitoring management criteria. In some embodiments, based at least in part on such analysis and/or AI or ML-based analysis by the AI component 212, the mitigation component 208 or AI component 212 can determine or identify a pattern in the current and/or historical information that can indicate what is causing the timeout condition to occur with regard to service requests or a service, and/or can determine or identify an adjustment to the timeout period associated with the service request or service that can mitigate future occurrences of such timeout condition with regard to service requests or the service, in accordance with the defined monitoring management criteria.

As another example, with regard to a service request failure that has occurred in connection with a task or transaction and/or one or more previous service request failures, the mitigation component 208 can determine whether a modification is to be made with regard to how a service is performed in response to a service request, an amount of time provided to perform a desired service requested by the service request, a type of service employed to provide the desired service requested by the service request, and/or other feature or characteristic associated with the service request or service, and, if so, the type of modification to make to, or with respect to, future service requests or services, based at least in part on the results of analyzing current information relating to the service request failure and/or historical information relating to previous service request failures and/or services associated therewith, in accordance with the defined monitoring management criteria. In certain embodiments, based at least in part on such analysis and/or AI or ML-based analysis by the AI component 212, the mitigation component 208 or AI component 212 can determine or identify a pattern in the current and/or historical information that can indicate what is causing the service request failure to occur with regard to service requests or a service, and/or can determine or identify a modification to make to, or with respect to, future service requests that can mitigate future occurrences of such service request failures with regard to service requests or the service, in accordance with the defined monitoring management criteria.

The mitigation component 208 can perform or facilitate performing (e.g., can engage another component, device, user, or entity to perform) a desired mitigation action to mitigate service request failures and/or timeout conditions associated with service requests, and/or can communicate mitigation action information (e.g., via the presentation component 210 or other component) to another component, device, user, or entity for consideration and/or to facilitate performance of the desired mitigation action.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

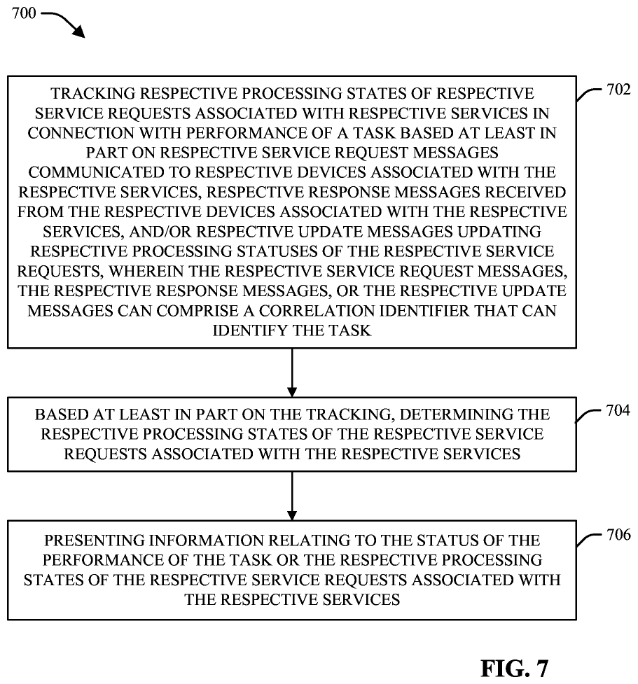

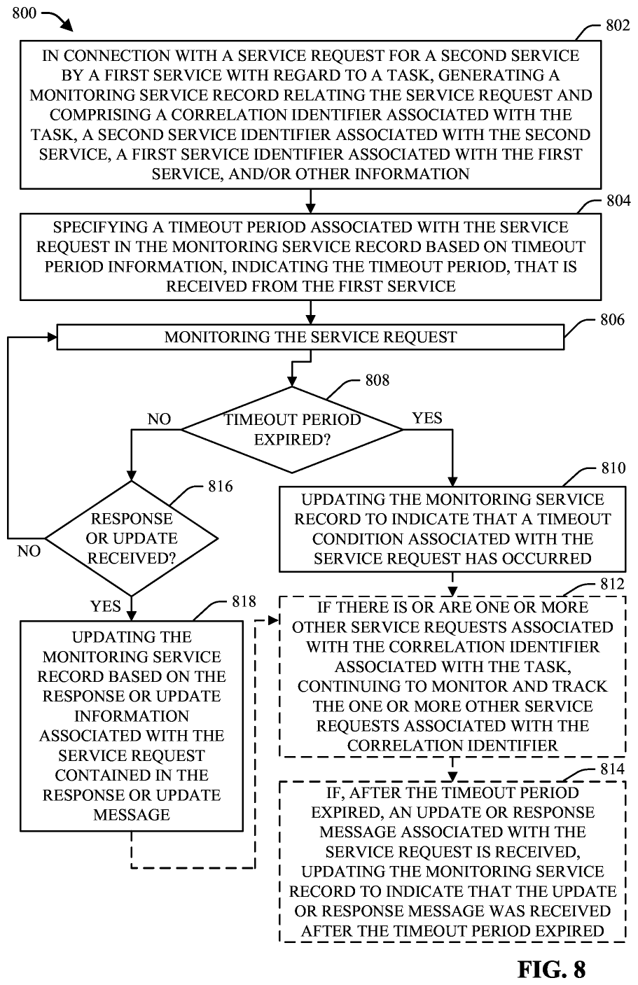

In view of the example systems and/or devices described herein, example methods that can be implemented in accordance with the disclosed subject matter can be further appreciated with reference to flowcharts in FIGS. 7-8. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 7 illustrates a flow chart of an example method 700 that can desirably (e.g., suitably, enhancedly, efficiently, or optimally) perform automated monitoring (e.g., automated long duration monitoring) of tasks (e.g., tasks associated with a transaction or other tasks), in accordance with various aspects and embodiments of the disclosed subject matter. The method 700 can be employed by, for example, a system comprising the monitor manager component, a processor component (e.g., of or associated with the monitor manager component), and/or data store (e.g., of or associated with the monitor manager component and/or the processor component).

At 702, respective processing states of respective service requests associated with respective services can be tracked in connection with performance of a task based at least in part on respective service request messages communicated to respective devices associated with the respective services, respective response messages received from the respective devices associated with the respective services, and/or respective update messages updating respective processing statuses of the respective service requests, wherein the respective service request messages, the respective response messages, or the respective update messages can comprise a correlation identifier that can identify the task. The monitor manager component can monitor and/or track the respective processing states (e.g., successful completion state, failure-to-complete state, or timeout state) of respective service requests associated with respective services in connection with performance of a task (e.g., task associated with a transaction or other task) based at least in part on the respective service request messages, the respective response, and/or the respective update messages. To facilitate the monitoring and/or tracking, the respective service request messages, the respective response messages, and/or the respective update messages can comprise the correlation identifier, which can identify the task, and can facilitate correlating or associating respective messages associated with the task with each other. In some embodiments, with regard to each service request associated with the task, the monitor manager component can generate a monitoring service record, comprising the correlation identifier associated with the task, the service request, and/or a previous service request that led to the service request being made, wherein the monitor manager component can update the monitoring service record associated with the service request with update information, such as a status update, relating to the service request as the monitor manager component learns of, identifies, or determines a status of the service request, such as described herein. The monitoring service record also can include a timeout period associated with the service request, wherein the timeout period can be specified by the service that is issuing the service request for the requested service, and can indicate the amount of time that the requested service has to respond to the service request to indicate whether the service has been successfully performed and completed, or has failed to be successfully performed and completed.

At 704, based at least in part on the tracking, the respective processing states of the respective service requests associated with the respective services can be determined. For instance, based at least in part on the tracking, the monitor manager component can receive (e.g., obtain or capture) information of or relating to the respective service request messages, the respective response messages, and/or the respective update messages. The monitor manager component can analyze such information of or relating to the respective service request messages, the respective response messages, and/or the respective update messages. Based at least in part on the results of the analysis, the monitor manager component can determine or identify the respective processing states of the respective service requests associated with the respective services. For instance, the monitor manager component can determine that a service request message that requested a particular service has a successful completion state (or successful performance state), if there was a response or update message from the requesting service indicating that the requested particular service has been successfully performed and completed (e.g., the particular service performed the requested sub-task), or the interceptor component associated with the requesting service intercepted a response message from the particular service indicating that the requested particular service has been successfully performed and completed. With regard to service failure, the monitor manager component can determine that a service request message that requested a particular service has a failure state (e.g., failure-to-complete state), if there was a update message from the requesting service or a response message from the particular service (e.g., intercepted by the interceptor component) indicating that the requested particular service was unable to be successfully performed and completed (e.g., the particular service failed to perform the requested sub-task). With regard to a timeout, the monitor manager component can determine that a service request message that requested a particular service has a timeout state, if there was no update message received from the requesting service or response message intercepted from the particular service within a specified timeout period associated with the service request, wherein whether the service was successfully completed or not can be unknown to the monitor manager component at the time that the specified timeout period elapsed.

At 706, information relating to the status of the performance of the task or the respective processing states of the respective service requests associated with the respective services can be presented. The monitor manager component can present (e.g., communicate, display, or otherwise present) the information relating to the status of the performance of the task or the respective processing states of the respective service requests associated with the respective services that are associated with the task.

FIG. 8 presents a flow chart of another example method 800 that can desirably (e.g., suitably, efficiently, or optimally) perform automated monitoring (e.g., automated long duration monitoring) of tasks (e.g., tasks associated with a transaction or other tasks), in accordance with various aspects and embodiments of the disclosed subject matter. The method 800 can be employed by, for example, a system comprising the monitor manager component, a processor component (e.g., of or associated with the monitor manager component), and/or data store (e.g., of or associated with the monitor manager component and/or the processor component).

At 802, in connection with a service request for a second service by a first service with regard to a task, a monitoring service record relating the service request for the second service by the first service can be generated, wherein the monitoring service record can comprise a correlation identifier associated with the task, a second service identifier associated with the second service, a first service identifier associated with the first service, and/or other information relating to the task or the service request. The monitor manager component can generate the monitoring service record relating the service request for the second service by the first service, for example, when the first service is preparing to send, or otherwise in connection with the first service sending, a service request message to the second service to request (e.g., to make an asynchronous request for) the second service in connection with the task. The service request may be a first service request relating to the task (e.g., the first service may be initiating the task or transaction associated therewith), or may be a downstream service request being made by the first service for the second service in response to the first service receiving, from another service, a previous service request message requesting the first service in connection with the task. The service request can be an asynchronous service request or a synchronous service request. The correlation identifier can be associated with (e.g., mapped or linked to, correlated with, or otherwise associated with) the task, the first service, and/or the other service that initiated the task or previously requested the first service in connection with the task. The correlation identifier can correlate or associate all service requests and messages associated with the service requests, which can be related to the task, to the task and/or each other.

At 804, a timeout period associated with the service request can be specified in the monitoring service record based at least in part on timeout period information, indicating the timeout period, that is received from the first service. The monitor manager component can receive the timeout period information from the first service (e.g., from a first device associated with the first service). Based at least in part on the received timeout period information, the monitor manager component can store or specify the timeout period in the monitoring service record.

At 806, the service request can be monitored. The first service can send the service request message to the second service (e.g., to a second device associated with the second service) to request the second service (e.g., to request that the second service be performed). The monitor manager component can monitor or track events relating to the service request, including monitoring or tracking messages (e.g., response or update messages) relating to the service request, and/or monitoring or tracking the amount of time that has elapsed since the service request was issued and/or whether the timeout period has expired. The messages can comprise the correlation identifier, the first identifier associated with the first service, and/or the second identifier associated with the second service, to facilitate the monitoring and tracking of the messages and the status of the service request.

At 808, based at least in part on the monitoring of the service request, a determination can be made regarding whether the timeout period associated with the service request has expired. For instance, based at least in part on the monitoring of the service request, including the amount of time that the service request has been pending, the monitor manager component can determine whether the timeout period associated with the service request has expired, for example, without receiving a response or update message associated with the service request.

If it is determined that the timeout period has expired, at 810, the monitoring service record can be updated to indicate that a timeout condition associated with the service request has occurred. For instance, if the monitor manager component determines that the timeout period has expired, the monitor manager component can update the monitoring service record to indicate that the timeout condition associated with the service request has occurred.

In some embodiments, if there is or are one or more other service requests associated with the correlation identifier associated with the task, at 812, the one or more other service requests associated with the correlation identifier associated with the task can continue to be monitored and tracked. For example, if the monitor manager component determines or identifies that there is or are one or more other service requests associated with the correlation identifier associated with the task (e.g., long duration task or associated transaction), the monitor manager component can continue to monitor and track the one or more other service requests associated with the correlation identifier associated with the task.

In some embodiments, if, after the timeout period associated with the service request has expired, an update or response message associated with the service request is received (e.g., by the monitor manager component), at 814, the monitoring service record can be updated to indicate that the update or response message was received after the timeout period expired. For instance, if there is an interceptor component being employed and associated with the first service, the interceptor component may receive an update or response message associated with the service request from the second device associated with the second service after the timeout period expired, and the interceptor component can communicate an update message relating to the service request to the monitor manager component. In other embodiments, the first device associated with the first service may be able to receive a response or update message from the second device associated with the second service after the timeout period has expired (e.g., even if the first service specified the timeout period), and the first device can communicate an update message relating to the service request to the monitor manager component. If, after the timeout period associated with the service request has expired, an update or response message associated with the service request is received by the monitor manager component, the monitor manager component can update (e.g., modify) the monitoring service record to indicate that the update or response message was received after the timeout period expired, indicate whether the second service was performed or failed to be performed, indicate the amount of time that elapsed after the timeout period expired before the update or response message was received, and/or log other desired information relating to the service request.

Referring again to reference numeral 808, if, instead, at 808, it is determined that the timeout period has not expired, at 816, a determination can be made regarding whether a response or update message associated with the service request has been received. If the monitor manager component determines that the timeout period has not expired, the monitor manager component can determine whether a response or update message associated with the service request has been received, based at least in part on the monitoring or tracking of the service request, the correlation identifier associated with the service request and task, the second service identifier associated with the second service (e.g., the requested service), and/or other information.

If it is determined that a response or update message associated with the service request has not been received, the method 800 can proceed back to reference numeral 806, wherein the service request can continue to be monitored, and the method 800 can proceed from that point.

If, instead, at 816, it is determined that a response or update message associated with the service request has been received, at 818, the monitoring service record can be updated based at least in part on the response or update information associated with the service request contained in the response or update message. If the monitor manager component determines that the response or update message associated with the service request has been received, the monitor manager component can update (e.g., modify) the monitoring service record based at least in part on the response or update information associated with the service request contained in the response or update message. The response or update message can be received from the first device associated with the first service or the interceptor component associated with the first service. If the response or update information in the message indicates that the second service has been successfully performed (e.g., the second service successfully performed and completed the desired sub-task requested by the service request), the monitoring service record can update the monitor service record to indicate that the service request has been processed successfully (e.g., the second service successfully performed the desired sub-task or service, as requested by the service request). If, instead, the response or update information in the message indicates that the second service has not been successfully performed (e.g., the second service has failed to perform the desired sub-task requested by the service request), the monitoring service record can update the monitor service record to indicate that the service request has not been processed successfully (e.g., the second service was not able to, or failed to, successfully perform the desired sub-task or service that was requested by the service request).

In some embodiments, at this point, the method 800 can proceed to reference numeral 812, wherein the method 800 can continue to monitor and track the one or more other service requests (if any) associated with the correlation identifier associated with the task.

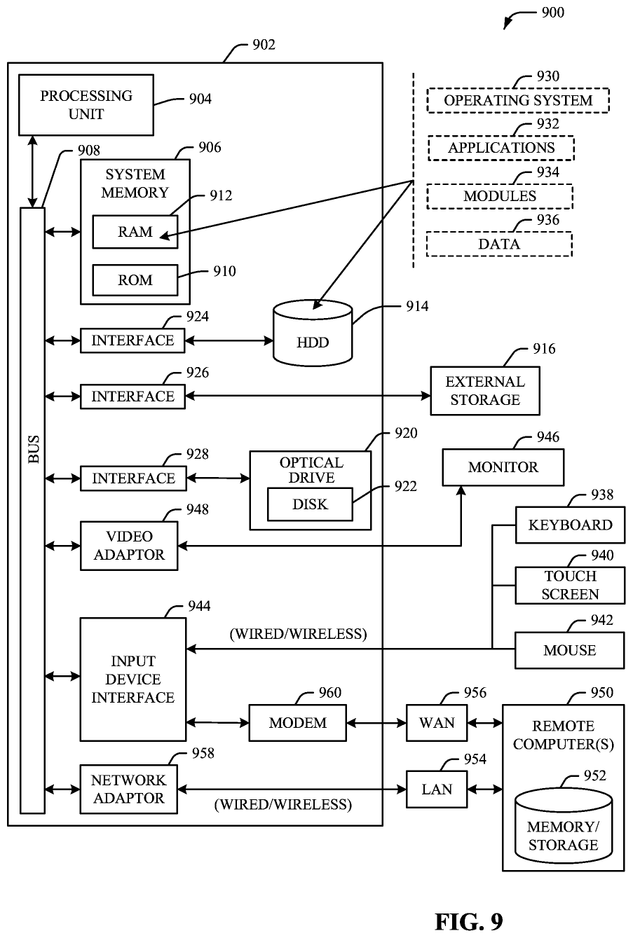

In order to provide additional context for various embodiments described herein, FIG. 9 and the following discussion are intended to provide a brief, general description of a suitable computing environment 900 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enable with a security module, such as a trusted processing module (TPM). For instance with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can be also connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are example and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956, e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), Internet of things (IoT) device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., node, device, communication network, service, monitor manager component, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
tracking, by a system comprising a processor, respective processing states of respective service requests associated with respective services in connection with performance of a task based on respective service request messages communicated to respective devices associated with the respective services, respective response messages received from the respective devices associated with the respective services, or respective update messages updating respective processing statuses of the respective service requests, wherein the respective service request messages, the respective response messages, or the respective update messages comprise a correlation identifier that identifies the task;
based on the tracking, determining, by the system, the respective processing states of the respective service requests associated with the respective services; and
determining, by the system, a status of the performance of the task based on the respective processing states of the respective service requests associated with the respective services.

2. The method of claim 1, further comprising:
presenting, by the system, information relating to the status of the performance of the task or the respective processing states of the respective service requests associated with the respective services.

3. The method of claim 1, wherein the respective services comprise a first service and a second service, wherein the respective devices comprise a first device associated with the first service, wherein the respective service request messages comprise a service request message, and wherein the method further comprises:
in connection with the service request message, from the first device, that requests or invokes the second service, receiving, by the system, a monitoring request message from the first device or an interceptor device, wherein the monitoring request message specifies a timeout period for performance of a service task by the second service; and
generating, by the system, a monitoring service record relating to the service request for the second service, wherein the monitoring service record comprises the timeout period for the performance of the service task by the second service and the correlation identifier associated with the task, a first service identifier associated with the first service, or a second service identifier associated with the second service, and wherein the performance of the service task facilitates the performance of the task.

4. The method of claim 3, wherein the respective services comprise a third service, wherein the respective devices comprise a second device associated with the second service, wherein the respective service request messages comprise a first service request message and a second service request message, wherein the service request message is the first service request message, wherein the monitoring request message is a first monitoring request message, wherein the monitoring service record is a first monitoring service record, wherein the timeout period is a first timeout period, wherein the service task is a first service task, and wherein the method further comprises:
in connection with the second service request message, from the second device, that requests or invokes the third service, receiving, by the system, a second monitoring request message from the second device or the interceptor device, wherein the second monitoring request message specifies a second timeout period for performance of a second service task by the third service; and
generating, by the system, a second monitoring service record relating to the second service request for the third service, wherein the second monitoring service record comprises the second timeout period for the performance of the second service task by the third service and the correlation identifier associated with the task, a second service identifier associated with the second service, a third service identifier associated with the third service, or a monitoring service record identifier associated with the monitoring service record, and wherein the performance of the second service task facilitates the performance of the task.

5. The method of claim 4, wherein the interceptor device intercepts at least one of the first service request message or the second service request message.

6. The method of claim 5, wherein at least one of the tracking, the determining of the respective processing states, or the intercepting of at least one of the first service request message or the second service request message are able to be performed agnostically and independently with respect to, and without interacting with, executable code and programming languages employed by the respective services.

7. The method of claim 3, wherein the respective processing states comprise a processing state of the service request, wherein the tracking comprises tracking the processing state of the service request, wherein the respective devices comprise a second device associated with the second service, wherein the respective response messages comprise a response message received by the first device from the second device, and wherein the method further comprises:
receiving, by the system, an update message from the first device or the interceptor device, wherein the update message indicates that the service task is successfully performed, wherein the update message is based on the response message indicating that the service task is successfully performed by the second service, and wherein the response message comprises the correlation identifier and a monitoring service record identifier associated with the monitoring service record; and
based on the update message indicating that the service task is successfully performed, updating, by the system, the processing state in the monitoring service record to indicate that the service task is successfully performed.

8. The method of claim 3, wherein the respective processing states comprise a processing state of the service request, wherein the tracking comprises tracking the processing state of the service request, wherein the respective devices comprise a second device associated with the second service, wherein the respective response messages comprise a response message received by the first device from the second device, and wherein the method further comprises:
receiving, by the system, an update message from the first device or the interceptor device, wherein the update message indicates that the service task has failed to be successfully performed, wherein the update message is based on the response message indicating that the service task has failed to be successfully performed, and wherein the response message comprises the correlation identifier and a monitoring service record identifier associated with the monitoring service record; and
based on the update message indicating that the service task has failed to be successfully performed, updating, by the system, the processing state in the monitoring service record to indicate that the service task has failed to be successfully performed.

9. The method of claim 8, further comprising:
analyzing, by the system, historical data relating previous service requests for services, comprising previous service requests for the second service; and
based on a result of the analyzing, determining, by the system, a mitigation action that is able to be performed to facilitate mitigating or reducing failures to successfully perform subsequent service requests for services, comprising subsequent service requests for the second service.

10. The method of claim 3, wherein the respective processing states comprise a processing state of the service request, wherein the tracking comprises tracking the processing state of the service request, and wherein the method further comprises:
determining, by the system, that a timeout has occurred with regard to the service request, wherein the timeout indicates that the timeout period for the performance of the service task by the second service has elapsed without a response message indicating a successful performance of the service task or failure to successfully perform the service task; and
based on the determining that the timeout has occurred, updating, by the system, the processing state in the monitoring service record to indicate that the timeout has occurred.

11. The method of claim 10, further comprising:
analyzing, by the system, historical data relating previous service requests for services, comprising previous service requests for the second service; and
based on a result of the analyzing, determining, by the system, a mitigation action that is able to be performed to facilitate mitigating or reducing timeouts relating to performance of subsequent service requests for services, comprising subsequent service requests for the second service.

12. The method of claim 11, wherein the determining of the mitigation action comprises determining an adjustment to the timeout period to facilitate the mitigating or reducing of timeouts relating to the performance of the subsequent service requests for services, comprising the subsequent service requests for the second service.

13. The method of claim 1, wherein the task relates to a transaction involving at least one of a product, a service, or a subscription.

14. The method of claim 1, wherein at least a portion of the respective service requests for the respective services are asynchronous service requests.

15. A system, comprising:
a memory that stores computer executable components; and
a processor that executes computer executable components stored in the memory, wherein the computer executable components comprise:
a monitor component that monitors and tracks respective processing states of respective service requests associated with respective services in connection with a transaction based on respective items of service request data communicated to respective nodes associated with the respective services, respective items of response data received from the respective nodes associated with the respective services, or respective items of update data that update respective processing statuses of the respective service requests, wherein the respective items of service request data, the respective items of response data, or the respective items of update data comprise a transaction identifier that identifies the transaction; and
a monitor manager component that determines the respective processing states of the respective service requests associated with the respective services, based on the monitoring and the tracking, and determines a status of the transaction based on the respective processing states of the respective service requests associated with the respective services.

16. The system of claim 15, wherein the monitor manager component communicates or presents status data relating to the status of transaction or the respective processing states of the respective service requests associated with the respective services.

17. The system of claim 15, wherein the respective items of service request data comprise an item of service request data, wherein the respective services comprise a first service and a second service, wherein the respective nodes comprise a first node,
wherein, in connection with the item of service request data, from the first node, that requests or invokes the second service, the manager component receives monitoring request data from the node or an interceptor device, wherein the monitoring request data indicates a timeout period for performance of a service task by the second service, and
wherein the monitor manager component creates a monitoring service record relating to the service request for the second service, wherein the monitoring service record comprises the timeout period for the performance of the service task by the second service and the transaction identifier associated with the transaction, a first service identifier associated with the first service, or a second service identifier associated with the second service, and wherein the performance of the service task facilitates execution of the transaction.

18. The system of claim 17, wherein the respective processing states comprise a processing state of the service request, wherein the monitor component tracks the processing state of the service request, wherein the respective nodes comprise a second node associated with the second service,
wherein the monitor manager component receives an item of update data from the first node or the interceptor device, or determines that the timeout period has expired, wherein the respective items of update data comprise the item of update data, wherein the item of update data indicates that the service task has been successfully performed or has failed to have been successfully performed based on an item of response data received by the first node or the interceptor device from the second node, wherein the respective items of response data comprise the item of response data, wherein the item of response data comprises the transaction identifier and a monitoring service record identifier that identifies the monitoring service record, and
wherein, based on one of the item of update data indicating that the service task has been successfully performed, the item of update data indicating that the service task has failed to have been successfully performed, or determining that the timeout period has expired, the monitor manager component one of updates the processing state in the monitoring service record to indicate that the service task have been successfully performed, updates the processing state in the monitoring service record to indicate that the service task has failed to have been successfully performed, or updates the processing state in the monitoring service record to indicate that the timeout period has expired.

19. A non-transitory machine-readable medium, comprising executable instructions that, when executed by a processor, facilitate performance of operations, comprising:
monitoring respective processing states of respective service requests associated with respective services in connection with performance of a task based on respective service request messages communicated to respective devices associated with the respective services, respective response messages received from the respective devices associated with the respective services, or respective update messages updating respective processing statuses of the respective service requests, wherein the respective service request messages, the respective response messages, or the respective update messages comprise a correlation identifier that identifies the task;
based on the monitoring, determining the respective processing states of the respective service requests associated with the respective services; and
determining a status of the performance of the task based on the respective processing states of the respective service requests associated with the respective services.

20. The non-transitory machine-readable medium of claim 19, wherein the operations further comprise:
presenting status data relating to the status of the performance of the task or the respective processing states of the respective service requests associated with the respective services.
